(19) United States
(12) Patent Application Publication
(10) Pub. No.: US 2023/0164636 A1
(43) Pub. Date: May 25, 2023

(54) MBS CONFIGURATION OPTIMIZATION BASED ON QUALITY OF EXPERIENCE FEEDBACK

(71) Applicant: Parsa Wireless Communications LLC, Stamford, CT (US)

(72) Inventor: Alireza Babaei, Fairfax, VA (US)

(73) Assignee: Parsa Wireless Communications LLC, Stamford, NY (US)

(21) Appl. No.: 17/991,363

(22) Filed: Nov. 21, 2022

Related U.S. Application Data
(60) Provisional application No. 63/281,870, filed on Nov. 22, 2021.

(51) Int. Cl. H04W 28/24; H04W 4/50; H04W 24/10

(52) U.S. Cl. CPC H04W 28/24; H04W 4/50; H04W 24/10; H04W 4/06

(57) ABSTRACT

A method of multicast and broadcast services (MBS) data transmission includes receiving, by a user equipment (UE) from a base station (BS), one or more first messages, which can include, for example, one or more first configuration parameters, with one or more first values, associated with MBS data transmission and one or more second configuration parameters for reporting one or more quality of experience metrics. The method also includes transmitting a report based on the one or more second configuration parameters and receiving, by the UE from the BS and in response to transmitting the report, one or more second messages comprising the one or more first configuration parameters, with one or more second values.

### CROSS-REFERENCE TO RELATED APPLICATIONS

This application claims priority under 35 USC § 119(e) from U.S. Provisional Patent Application No. 63/281,870, filed on Nov. 22, 2021 (“the provisional application”); the content of the provisional patent application is incorporated herein by reference.

### BACKGROUND OF THE INVENTION

The present invention is directed to 5G, which is the 5^{th} generation mobile network. It is a new global wireless standard after 1G, 2G, 3G, and 4G networks. 5G enables networks designed to connect machines, objects and devices.

The invention includes providing various capabilities for multicast and broadcast services (MBS), for example, multicast and broadcast modes. The inventive MBS capabilities include, but are not limited to, facilitating or enhancing feedback for optimization of MBS, such as MS broadcast modes and/or feedback while in an idle/inactive state.

### SUMMARY OF THE INVENTION

In an embodiment, the invention provides a method of multicast and broadcast services (MBS) data transmission includes receiving, by a user equipment (UE) from a base station (BS), one or more first messages, which can include, for example, one or more first configuration parameters, with one or more first values, associated with MBS data transmission and one or more second configuration parameters for reporting one or more quality of experience metrics. The method also includes transmitting a report based on the one or more second configuration parameters and receiving, by the UE from the BS and in response to transmitting the report, one or more second messages comprising the one or more first configuration parameters, with one or more second values.

The one or more first messages and the one or more second messages may be radio resource control (RRC) messages. Transmitting the report may be further based on a radio resource control (RRC) message. For that matter, transmitting the report may occur while the user equipment (UE) is in a radio resource control (RRC) connected state and may occur while the user equipment (UE) is in a radio resource control (RRC) idle state or an RRC inactive state. Preferably, the report comprises values of the one or more quality of experience metrics and the receiving of the one or more second messages is based on the one or more second values.

The method also can include receiving, before receiving the one or more second messages, first multicast and broadcast services (MBS) data based on the one or more first values of the one or more first configuration parameters and receiving, after receiving the one or more second messages, second MBS data based on the one or more second values of the one or more first configuration parameters. And the one or more first configuration parameters may include multicast control channel (MCCH) configuration parameters of one or more MCCHs. In that case, the method can further include receiving control information via the one or more multicast control channels (MCCHs) and/or receiving and processing the one or more multicast traffic channels (MTCHs) based on the control information. The method can also include receiving the multicast and broadcast services (MBS) data based on the one or more multicast traffic channels (MTCHs).

In the method, the one or more first configuration parameters comprise first multicast and broadcast services (MBS) parameters associated with a first MBS bundle and second MBS parameters associated with a second MBS bundle. The report can include time-stamped measurements associated with the one or more quality of experience metrics and/or location-stamped measurements associated with the one or more quality of experience metrics and/or receiving control information indicating a triggering of the reporting the one or more quality of experience metrics.

Triggering of the reporting can be based on physical layer signaling and/or based on medium access control (MAC) layer signaling. One or more quality of experience metrics may be based on at least one of a received signal received power (RSRP), a received signal received quality (RSRQ) and a block error rate (BLER). The one or more quality of experience metrics may be associated with at least one of a multicast control channel (MCCH) and a multicast traffic channel (MTCH). At least a portion of the one or more first configuration parameters may be received based on a broadcast message. And the broadcast message may embody or include system information indicating the at least a portion of the one or more first configuration parameters.

The broadcast message may be a system information block (SIB) message. The system information block (SIB) message may be associated with quality of experience measurement and reporting. The broadcast message may include multicast and broadcast services (MBS) bundle-specific configuration parameters. For that matter, the method can include receiving multicast control channel (MCCH) configuration parameters comprising at least a portion of the one or more first configuration parameters. The multicast control channel (MCCH) configuration parameters may embody or include multicast and broadcast services (MBS) bundle-specific configuration parameters. The one or more second configuration parameters may embody of include an information element that is a trigger for reporting the one or more quality of experience metrics.

The transmitting the report may be further based upon one or more criteria. The one or more criteria may be based on at least one of a range of received signal received power (RSRP), a received signal received quality (RSRQ) and a block error rate (BLER). Transmitting the report may be based on at least one of a measurement threshold, a measurement range, one or more time windows, one or more reporting trigger events and one or more reporting time windows. The transmitting of the report may also be based on randomization parameter. In that case, the randomization parameter can be based on a probability and/or based on a user equipment (UE) identifier. In the method, the user equipment (UE) may be in one of a radio resource control (RRC) inactive state and an RRC idle state and transmitting the report may be based on a configured grant resource.

The method also can include receiving configuration parameters of a configured grant configuration in an inactive state, wherein the configured grant resource is associated with the configured grant configuration. The method may further include receiving a radio resource control (RRC) release message comprising the configuration parameters of the configured grant configuration. In the method, the user equipment (UE) can be in one of a radio resource control (RRC) inactive state and an RRC idle state and transmitting the report can be based on a random access process. And the method can also include receiving random access configuration parameters in an inactive state or an idle state, wherein the random access process is based on the random access configuration parameters.

### BRIEF DESCRIPTION OF THE DRAWINGS

FIG. 1 shows an example of a system of mobile communications according to some aspects of some of various exemplary embodiments of the present disclosure.

FIG. 2A and FIG. 2B show examples of radio protocol stacks for user plane and control plane, respectively, according to some aspects of some of various exemplary embodiments of the present disclosure.

FIG. 3A, FIG. 3B and FIG. 3C show example mappings between logical channels and transport channels in downlink, uplink and sidelink, respectively, according to some aspects of some of various exemplary embodiments of the present disclosure.

FIG. 4A, FIG. 4B and FIG. 4C show example mappings between transport channels and physical channels in downlink, uplink and sidelink, respectively, according to some aspects of some of various exemplary embodiments of the present disclosure.

FIG. 5A, FIG. 5B, FIG. 5C and FIG. 5D show examples of radio protocol stacks for NR sidelink communication according to some aspects of some of various exemplary embodiments of the present disclosure.

FIG. 6 shows example physical signals in downlink, uplink and sidelink according to some aspects of some of various exemplary embodiments of the present disclosure.

FIG. 7 shows examples of Radio Resource Control (RRC) states and transitioning between different RRC states according to some aspects of some of various exemplary embodiments of the present disclosure.

FIG. 8 shows example frame structure and physical resources according to some aspects of some of various exemplary embodiments of the present disclosure.

FIG. 9 shows example component carrier configurations in different carrier aggregation scenarios according to some aspects of some of various exemplary embodiments of the present disclosure.

FIG. 10 shows example bandwidth part configuration and switching according to some aspects of some of various exemplary embodiments of the present disclosure.

FIG. 11 shows example four-step contention-based and contention-free random access processes according to some aspects of some of various exemplary embodiments of the present disclosure.

FIG. 12 shows example two-step contention-based and contention-free random access processes according to some aspects of some of various exemplary embodiments of the present disclosure.

FIG. 13 shows example time and frequency structure of Synchronization Signal and Physical Broadcast Channel (PBCH) Block (SSB) according to some aspects of some of various exemplary embodiments of the present disclosure.

FIG. 14 shows example SSB burst transmissions according to some aspects of some of various exemplary embodiments of the present disclosure.

FIG. 15 shows example components of a user equipment and a base station for transmission and/or reception according to some aspects of some of various exemplary embodiments of the present disclosure.

FIG. 16 shows an example MBS interest indication signaling according to some aspects of some of various exemplary embodiments of the present disclosure.

FIG. 17 shows an example MDT configuration for MBS using common signaling and MDT Reporting according to some aspects of some of various exemplary embodiments of the present disclosure.

FIG. 18 shows an example process for randomly selecting relevant UEs for measurement and reporting of MDT data for MBS according to some aspects of some of various exemplary embodiments of the present disclosure.

FIG. 19 shows an example process according to some aspects of some of various exemplary embodiments of the present disclosure.

### DETAILED DESCRIPTION

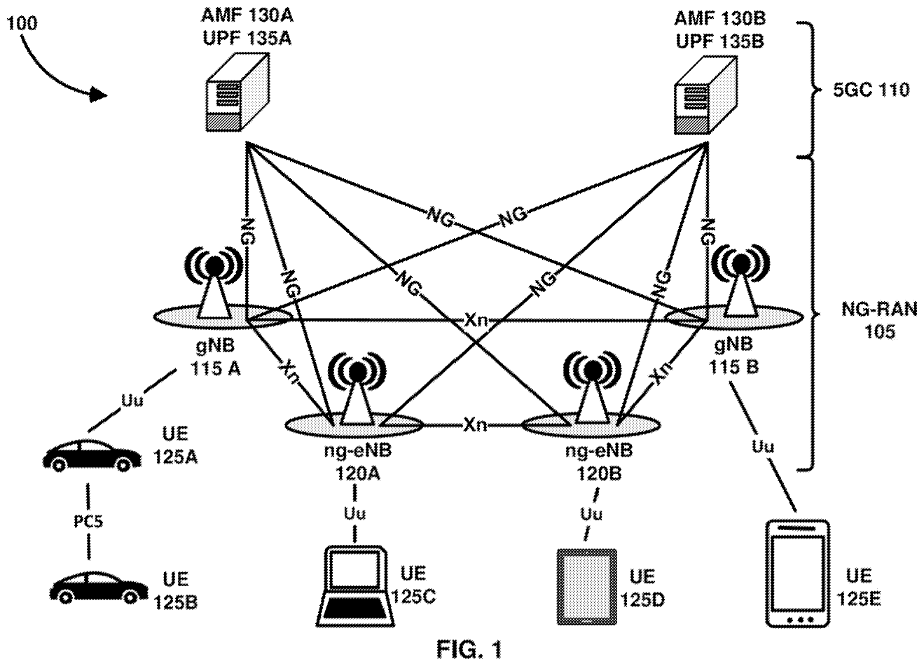

FIG. 1 shows an example of a system of mobile communications 100 according to some aspects of some of various exemplary embodiments of the present disclosure. The system of mobile communication 100 may be operated by a wireless communications system operator such as a Mobile Network Operator (MNO), a private network operator, a Multiple System Operator (MSO), an Internet of Things (IOT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial IOT (IIOT), etc.

The system of mobile communications 100 may enable various types of applications with different requirements in terms of latency, reliability, throughput, etc. Example supported applications include enhanced Mobile Broadband (eMBB), Ultra-Reliable Low-Latency Communications (URLLC), and massive Machine Type Communications (mMTC). eMBB may support stable connections with high peak data rates, as well as moderate rates for cell-edge users. URLLC may support application with strict requirements in terms of latency and reliability and moderate requirements in terms of data rate. Example mMTC application includes a network of a massive number of IoT devices, which are only sporadically active and send small data payloads.

The system of mobile communications 100 may include a Radio Access Network (RAN) portion and a core network portion. The example shown in FIG. 1 illustrates a Next Generation RAN (NG-RAN) 105 and a 5G Core Network (5GC) 110 as examples of the RAN and core network, respectively. Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), etc. Other examples of core network include Evolved Packet Core (EPC), UMTS Core Network (UCN), etc. The RAN implements a Radio Access Technology (RAT) and resides between User Equipments (UEs) 125 and the core network. Examples of such RATs include New Radio (NR), Long Term Evolution (LTE) also known as Evolved Universal Terrestrial Radio Access (EUTRA), Universal Mobile Telecommunication System (UMTS), etc. The RAT of the example system of mobile communications 100 may be NR. The core network resides between the RAN and one or more external networks (e.g., data networks) and is responsible for functions such as mobility management, authentication, session management, setting up bearers and application of different Quality of Services (QoSs). The functional layer between the UE 125 and the RAN (e.g., the NG-RAN 105) may be referred to as Access Stratum (AS) and the functional layer between the UE 125 and the core network (e.g., the 5GC 110) may be referred to as Non-access Stratum (NAS).

The UEs 125 may include wireless transmission and reception means for communications with one or more nodes in the RAN, one or more relay nodes, or one or more other UEs, etc. Example of UEs include, but are not limited to, smartphones, tablets, laptops, computers, wireless transmission and/or reception units in a vehicle, V2X or Vehicle to Vehicle (V2V) devices, wireless sensors, IoT devices, IIOT devices, etc. Other names may be used for UEs such as a Mobile Station (MS), terminal equipment, terminal node, client device, mobile device, etc.

The RAN may include nodes (e.g., base stations) for communications with the UEs. For example, the NG-RAN 105 of the system of mobile communications 100 may comprise nodes for communications with the UEs 125. Different names for the RAN nodes may be used, for example depending on the RAT used for the RAN. A RAN node may be referred to as Node B (NB) in a RAN that uses the UMTS RAT. A RAN node may be referred to as an evolved Node B (eNB) in a RAN that uses LTE/EUTRA RAT. For the illustrative example of the system of mobile communications 100 in FIG. 1, the nodes of an NG-RAN 105 may be either a next generation Node B (gNB) 115 or a next generation evolved Node B (ng-eNB) 120. In this specification, the terms base station, RAN node, gNB and ng-eNB may be used interchangeably. The gNB 115 may provide NR user plane and control plane protocol terminations towards the UE 125. The ng-eNB 120 may provide E-UTRA user plane and control plane protocol terminations towards the UE 125. An interface between the gNB 115 and the UE 125 or between the ng-eNB 120 and the UE 125 may be referred to as a Uu interface. The Uu interface may be established with a user plane protocol stack and a control plane protocol stack. For a Uu interface, the direction from the base station (e.g., the gNB 115 or the ng-eNB 120) to the UE 125 may be referred to as downlink and the direction from the UE 125 to the base station (e.g., gNB 115 or ng-eNB 120) may be referred to as uplink.

The gNBs 115 and ng-eNBs 120 may be interconnected with each other by means of an Xn interface. The Xn interface may comprise an Xn User plane (Xn-U) interface and an Xn Control plane (Xn-C) interface. The transport network layer of the Xn-U interface may be built on Internet Protocol (IP) transport and GPRS Tunneling Protocol (GTP) may be used on top of User Datagram Protocol (UDP)/IP to carry the user plane protocol data units (PDUs). Xn-U may provide non-guaranteed delivery of user plane PDUs and may support data forwarding and flow control. The transport network layer of the Xn-C interface may be built on Stream Control Transport Protocol (SCTP) on top of IP. The application layer signaling protocol may be referred to as XnAP (Xn Application Protocol). The SCTP layer may provide the guaranteed delivery of application layer messages. In the transport IP layer, point-to-point transmission may be used to deliver the signaling PDUs. The Xn-C interface may support Xn interface management, UE mobility management, including context transfer and RAN paging, and dual connectivity.

The gNBs 115 and ng-eNBs 120 may also be connected to the 5GC 110 by means of the NG interfaces, more specifically to an Access and Mobility Management Function (AMF) 130 of the 5GC 110 by means of the NG-C interface and to a User Plane Function (UPF) 135 of the 5GC 110 by means of the NG-U interface. The transport network layer of the NG-U interface may be built on IP transport and GTP protocol may be used on top of UDP/IP to carry the user plane PDUs between the NG-RAN node (e.g., gNB 115 or ng-eNB 120) and the UPF 135. NG-U may provide non-guaranteed delivery of user plane PDUs between the NG-RAN node and the UPF. The transport network layer of the NG-C interface may be built on IP transport. For the reliable transport of signaling messages, SCTP may be added on top of IP. The application layer signaling protocol may be referred to as NGAP (NG Application Protocol). The SCTP layer may provide guaranteed delivery of application layer messages. In the transport, IP layer point-to-point transmission may be used to deliver the signaling PDUs. The NG-C interface may provide the following functions: NG interface management; UE context management; UE mobility management; transport of NAS messages; paging; PDU Session Management; configuration transfer; and warning message transmission.

The gNB 115 or the ng-eNB 120 may host one or more of the following functions: Radio Resource Management functions such as Radio Bearer Control, Radio Admission Control, Connection Mobility Control, Dynamic allocation of resources to UEs in both uplink and downlink (e.g., scheduling); IP and Ethernet header compression, encryption and integrity protection of data; Selection of an AMF at UE attachment when no routing to an AMF can be determined from the information provided by the UE; Routing of User Plane data towards UPF(s); Routing of Control Plane information towards AMF; Connection setup and release; Scheduling and transmission of paging messages; Scheduling and transmission of system broadcast information (e.g., originated from the AMF); Measurement and measurement reporting configuration for mobility and scheduling; Transport level packet marking in the uplink; Session Management; Support of Network Slicing; QoS Flow management and mapping to data radio bearers; Support of UEs in RRC Inactive state; Distribution function for NAS messages; Radio access network sharing; Dual Connectivity; Tight interworking between NR and E-UTRA; and Maintaining security and radio configuration for User Plane 5G system (5GS) Cellular IoT (CIoT) Optimization.

The AMF 130 may host one or more of the following functions: NAS signaling termination; NAS signaling security; AS Security control; Inter CN node signaling for mobility between 3GPP access networks; Idle mode UE Reachability (including control and execution of paging retransmission); Registration Area management; Support of intra-system and inter-system mobility; Access Authentication; Access Authorization including check of roaming rights; Mobility management control (subscription and policies); Support of Network Slicing; Session Management Function (SMF) selection; Selection of 5GS CIoT optimizations.

The UPF 135 may host one or more of the following functions: Anchor point for Intra-/Inter-RAT mobility (when applicable); External PDU session point of interconnect to Data Network; Packet routing & forwarding; Packet inspection and User plane part of Policy rule enforcement; Traffic usage reporting; Uplink classifier to support routing traffic flows to a data network; Branching point to support multi-homed PDU session; QoS handling for user plane, e.g. packet filtering, gating, UL/DL rate enforcement; Uplink Traffic verification (Service Data Flow (SDF) to QoS flow mapping); Downlink packet buffering and downlink data notification triggering.

As shown in FIG. 1, the NG-RAN 105 may support the PC5 interface between two UEs 125 (e.g., UE 125A and UE125B). In the PC5 interface, the direction of communications between two UEs (e.g., from UE 125A to UE 125B or vice versa) may be referred to as sidelink. Sidelink transmission and reception over the PC5 interface may be supported when the UE 125 is inside NG-RAN 105 coverage, irrespective of which RRC state the UE is in, and when the UE 125 is outside NG-RAN 105 coverage. Support of V2X services via the PC5 interface may be provided by NR sidelink communication and/or V2X sidelink communication.

PC5-S signaling may be used for unicast link establishment with Direct Communication Request/Accept message. A UE may self-assign its source Layer-2 ID for the PC5 unicast link for example based on the V2X service type. During unicast link establishment procedure, the UE may send its source Layer-2 ID for the PC5 unicast link to the peer UE, e.g., the UE for which a destination ID has been received from the upper layers. A pair of source Layer-2 ID and destination Layer-2 ID may uniquely identify a unicast link. The receiving UE may verify that the said destination ID belongs to it and may accept the Unicast link establishment request from the source UE. During the PC5 unicast link establishment procedure, a PC5-RRC procedure on the Access Stratum may be invoked for the purpose of UE sidelink context establishment as well as for AS layer configurations, capability exchange etc. PC5-RRC signaling may enable exchanging UE capabilities and AS layer configurations such as Sidelink Radio Bearer configurations between pair of UEs for which a PC5 unicast link is established.

NR sidelink communication may support one of three types of transmission modes (e.g., Unicast transmission, Groupcast transmission, and Broadcast transmission) for a pair of a Source Layer-2 ID and a Destination Layer-2 ID in the AS. The Unicast transmission mode may be characterized by: Support of one PC5-RRC connection between peer UEs for the pair; Transmission and reception of control information and user traffic between peer UEs in sidelink; Support of sidelink HARQ feedback; Support of sidelink transmit power control; Support of RLC Acknowledged Mode (AM); and Detection of radio link failure for the PC5-RRC connection. The Groupcast transmission may be characterized by: Transmission and reception of user traffic among UEs belonging to a group in sidelink; and Support of sidelink HARQ feedback. The Broadcast transmission may be characterized by: Transmission and reception of user traffic among UEs in sidelink.

A Source Layer-2 ID, a Destination Layer-2 ID and a PC5 Link Identifier may be used for NR sidelink communication. The Source Layer-2 ID may be a link-layer identity that identifies a device or a group of devices that are recipients of sidelink communication frames. The Destination Layer-2 ID may be a link-layer identity that identifies a device that originates sidelink communication frames. In some examples, the Source Layer-2 ID and the Destination Layer-2 ID may be assigned by a management function in the Core Network. The Source Layer-2 ID may identify the sender of the data in NR sidelink communication. The Source Layer-2 ID may be 24 bits long and may be split in the MAC layer into two bit strings: One bit string may be the LSB part (8 bits) of Source Layer-2 ID and forwarded to physical layer of the sender. This may identify the source of the intended data in sidelink control information and may be used for filtering of packets at the physical layer of the receiver; and the Second bit string may be the MSB part (16 bits) of the Source Layer-2 ID and may be carried within the Medium Access Control (MAC) header. This may be used for filtering of packets at the MAC layer of the receiver. The Destination Layer-2 ID may identify the target of the data in NR sidelink communication. For NR sidelink communication, the Destination Layer-2 ID may be 24 bits long and may be split in the MAC layer into two bit strings: One bit string may be the LSB part (16 bits) of Destination Layer-2 ID and forwarded to physical layer of the sender. This may identify the target of the intended data in sidelink control information and may be used for filtering of packets at the physical layer of the receiver; and the Second bit string may be the MSB part (8 bits) of the Destination Layer-2 ID and may be carried within the MAC header. This may be used for filtering of packets at the MAC layer of the receiver. The PC5 Link Identifier may uniquely identify the PC5 unicast link in a UE for the lifetime of the PC5 unicast link. The PC5 Link Identifier may be used to indicate the PC5 unicast link whose sidelink Radio Link failure (RLF) declaration was made and PC5-RRC connection was released.

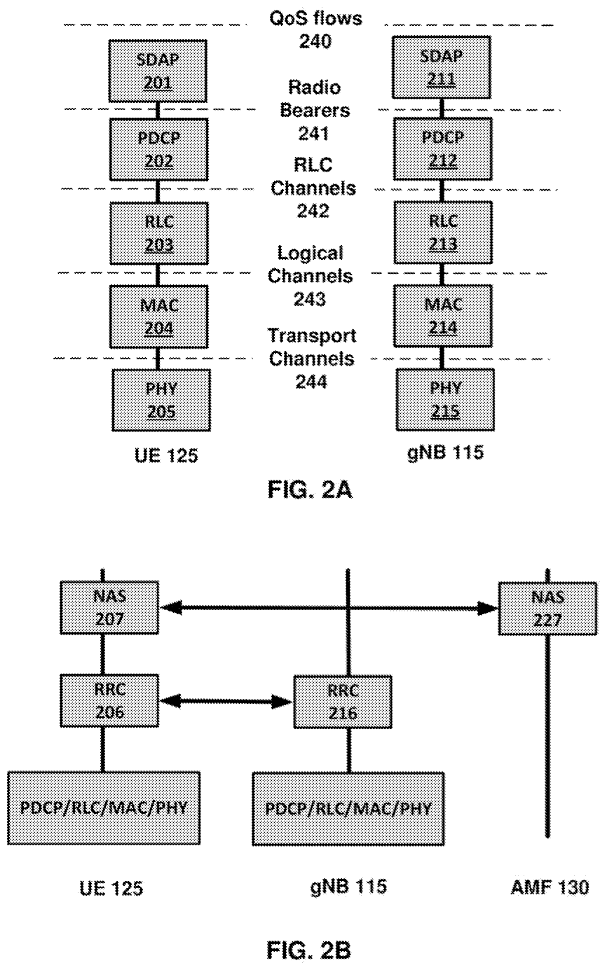

FIG. 2A and FIG. 2B show examples of radio protocol stacks for user plane and control plane, respectively, according to some aspects of some of various exemplary embodiments of the present disclosure. As shown in FIG. 2A, the protocol stack for the user plane of the Uu interface (between the UE 125 and the gNB 115) includes Service Data Adaptation Protocol (SDAP) 201 and SDAP 211, Packet Data Convergence Protocol (PDCP) 202 and PDCP 212, Radio Link Control (RLC) 203 and RLC 213, MAC 204 and MAC 214 sublayers of layer 2 and Physical (PHY) 205 and PHY 215 layer (layer 1 also referred to as L1).

The PHY 205 and PHY 215 offer transport channels 244 to the MAC 204 and MAC 214 sublayer. The MAC 204 and MAC 214 sublayer offer logical channels 243 to the RLC 203 and RLC 213 sublayer. The RLC 203 and RLC 213 sublayer offer RLC channels 242 to the PDCP 202 and PCP 212 sublayer. The PDCP 202 and PDCP 212 sublayer offer radio bearers 241 to the SDAP 201 and SDAP 211 sublayer. Radio bearers may be categorized into two groups: Data Radio Bearers (DRBs) for user plane data and Signaling Radio Bearers (SRBs) for control plane data. The SDAP 201 and SDAP 211 sublayer offers QoS flows 240 to 5GC.

The main services and functions of the MAC 204 or MAC 214 sublayer include: mapping between logical channels and transport channels; Multiplexing/demultiplexing of MAC Service Data Units (SDUs) belonging to one or different logical channels into/from Transport Blocks (TB) delivered to/from the physical layer on transport channels; Scheduling information reporting; Error correction through Hybrid Automatic Repeat Request (HARQ) (one HARQ entity per cell in case of carrier aggregation (CA)); Priority handling between UEs by means of dynamic scheduling; Priority handling between logical channels of one UE by means of Logical Channel Prioritization (LCP); Priority handling between overlapping resources of one UE; and Padding. A single MAC entity may support multiple numerologies, transmission timings and cells. Mapping restrictions in logical channel prioritization control which numerology(ies), cell(s), and transmission timing(s) a logical channel may use.

The HARQ functionality may ensure delivery between peer entities at Layer 1. A single HARQ process may support one TB when the physical layer is not configured for downlink/uplink spatial multiplexing, and when the physical layer is configured for downlink/uplink spatial multiplexing, a single HARQ process may support one or multiple TBs.

The RLC 203 or RLC 213 sublayer may support three transmission modes: Transparent Mode (TM); Unacknowledged Mode (UM); and Acknowledged Mode (AM). The RLC configuration may be per logical channel with no dependency on numerologies and/or transmission durations, and Automatic Repeat Request (ARQ) may operate on any of the numerologies and/or transmission durations the logical channel is configured with.

The main services and functions of the RLC 203 or RLC 213 sublayer depend on the transmission mode (e.g., TM, UM or AM) and may include: Transfer of upper layer PDUs; Sequence numbering independent of the one in PDCP (UM and AM); Error Correction through ARQ (AM only); Segmentation (AM and UM) and re-segmentation (AM only) of RLC SDUs; Reassembly of SDU (AM and UM); Duplicate Detection (AM only); RLC SDU discard (AM and UM); RLC re-establishment; and Protocol error detection (AM only).

The automatic repeat request within the RLC 203 or RLC 213 sublayer may have the following characteristics: ARQ retransmits RLC SDUs or RLC SDU segments based on RLC status reports; Polling for RLC status report may be used when needed by RLC; RLC receiver may also trigger RLC status report after detecting a missing RLC SDU or RLC SDU segment.

The main services and functions of the PDCP 202 or PDCP 212 sublayer may include: Transfer of data (user plane or control plane); Maintenance of PDCP Sequence Numbers (SNs); Header compression and decompression using the Robust Header Compression (ROHC) protocol; Header compression and decompression using EHC protocol; Ciphering and deciphering; Integrity protection and integrity verification; Timer based SDU discard; Routing for split bearers; Duplication; Reordering and in-order delivery; Out-of-order delivery; and Duplicate discarding.

The main services and functions of SDAP 201 or SDAP 211 include: Mapping between a QoS flow and a data radio bearer; and Marking QoS Flow ID (QFI) in both downlink and uplink packets. A single protocol entity of SDAP may be configured for each individual PDU session.

As shown in FIG. 2B, the protocol stack of the control plane of the Uu interface (between the UE 125 and the gNB 115) includes PHY layer (layer 1), and MAC, RLC and PDCP sublayers of layer 2 as described above and in addition, the RRC 206 sublayer and RRC 216 sublayer. The main services and functions of the RRC 206 sublayer and the RRC 216 sublayer over the Uu interface include: Broadcast of System Information related to AS and NAS; Paging initiated by 5GC or NG-RAN; Establishment, maintenance and release of an RRC connection between the UE and NG-RAN (including Addition, modification and release of carrier aggregation; and Addition, modification and release of Dual Connectivity in NR or between E-UTRA and NR); Security functions including key management; Establishment, configuration, maintenance and release of SRBs and DRBs; Mobility functions (including Handover and context transfer; UE cell selection and reselection and control of cell selection and reselection; and Inter-RAT mobility); QoS management functions; UE measurement reporting and control of the reporting; Detection of and recovery from radio link failure; and NAS message transfer to/from NAS from/to UE. The NAS 207 and NAS 227 layer is a control protocol (terminated in AMF on the network side) that performs the functions such as authentication, mobility management, security control, etc.

The sidelink specific services and functions of the RRC sublayer over the Uu interface include: Configuration of sidelink resource allocation via system information or dedicated signaling; Reporting of UE sidelink information; Measurement configuration and reporting related to sidelink; and Reporting of UE assistance information for SL traffic pattern(s).

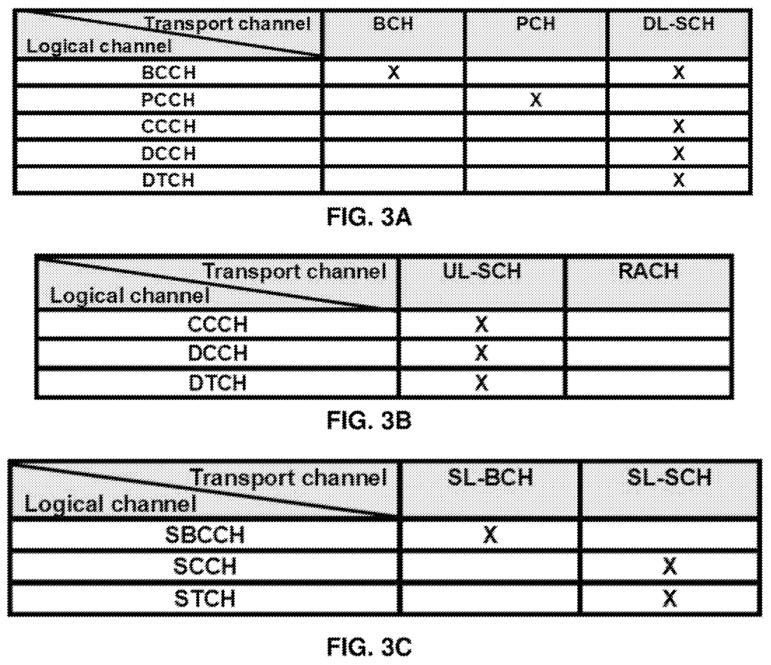

FIG. 3A, FIG. 3B and FIG. 3C show example mappings between logical channels and transport channels in downlink, uplink and sidelink, respectively, according to some aspects of some of various exemplary embodiments of the present disclosure. Different kinds of data transfer services may be offered by MAC. Each logical channel type may be defined by what type of information is transferred. Logical channels may be classified into two groups: Control Channels and Traffic Channels. Control channels may be used for the transfer of control plane information only. The Broadcast Control Channel (BCCH) is a downlink channel for broadcasting system control information. The Paging Control Channel (PCCH) is a downlink channel that carries paging messages. The Common Control Channel (CCCH) is channel for transmitting control information between UEs and network. This channel may be used for UEs having no RRC connection with the network. The Dedicated Control Channel (DCCH) is a point-to-point bi-directional channel that transmits dedicated control information between a UE and the network and may be used by UEs having an RRC connection. Traffic channels may be used for the transfer of user plane information only. The Dedicated Traffic Channel (DTCH) is a point-to-point channel, dedicated to one UE, for the transfer of user information. A DTCH may exist in both uplink and downlink. Sidelink Control Channel (SCCH) is a sidelink channel for transmitting control information (e.g., PC5-RRC and PC5-S messages) from one UE to other UE(s). Sidelink Traffic Channel (STCH) is a sidelink channel for transmitting user information from one UE to other UE(s). Sidelink Broadcast Control Channel (SBCCH) is a sidelink channel for broadcasting sidelink system information from one UE to other UE(s).

The downlink transport channel types include Broadcast Channel (BCH), Downlink Shared Channel (DL-SCH), and Paging Channel (PCH). The BCH may be characterized by: fixed, pre-defined transport format; and requirement to be broadcast in the entire coverage area of the cell, either as a single message or by beamforming different BCH instances. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; and the support for UE Discontinuous Reception (DRX) to enable UE power saving. The DL-SCH may be characterized by: support for HARQ; support for dynamic link adaptation by varying the modulation, coding and transmit power; possibility to be broadcast in the entire cell; possibility to use beamforming; support for both dynamic and semi-static resource allocation; support for UE discontinuous reception (DRX) to enable UE power saving. The PCH may be characterized by: support for UE discontinuous reception (DRX) to enable UE power saving (DRX cycle is indicated by the network to the UE); requirement to be broadcast in the entire coverage area of the cell, either as a single message or by beamforming different BCH instances; mapped to physical resources which can be used dynamically also for traffic/other control channels.

In downlink, the following connections between logical channels and transport channels may exist: BCCH may be mapped to BCH; BCCH may be mapped to DL-SCH; PCCH may be mapped to PCH; CCCH may be mapped to DL-SCH; DCCH may be mapped to DL-SCH; and DTCH may be mapped to DL-SCH.

The uplink transport channel types include Uplink Shared Channel (UL-SCH) and Random Access Channel(s) (RACH). The UL-SCH may be characterized by possibility to use beamforming; support for dynamic link adaptation by varying the transmit power and potentially modulation and coding; support for HARQ; support for both dynamic and semi-static resource allocation. The RACH may be characterized by limited control information; and collision risk.

In Uplink, the following connections between logical channels and transport channels may exist: CCCH may be mapped to UL-SCH; DCCH may be mapped to UL-SCH; and DTCH may be mapped to UL-SCH.

The sidelink transport channel types include: Sidelink broadcast channel (SL-BCH) and Sidelink shared channel (SL-SCH). The SL-BCH may be characterized by pre-defined transport format. The SL-SCH may be characterized by support for unicast transmission, groupcast transmission and broadcast transmission; support for both UE autonomous resource selection and scheduled resource allocation by NG-RAN; support for both dynamic and semi-static resource allocation when UE is allocated resources by the NG-RAN; support for HARQ; and support for dynamic link adaptation by varying the transmit power, modulation and coding.

In the sidelink, the following connections between logical channels and transport channels may exist: SCCH may be mapped to SL-SCH; STCH may be mapped to SL-SCH; and SBCCH may be mapped to SL-BCH.

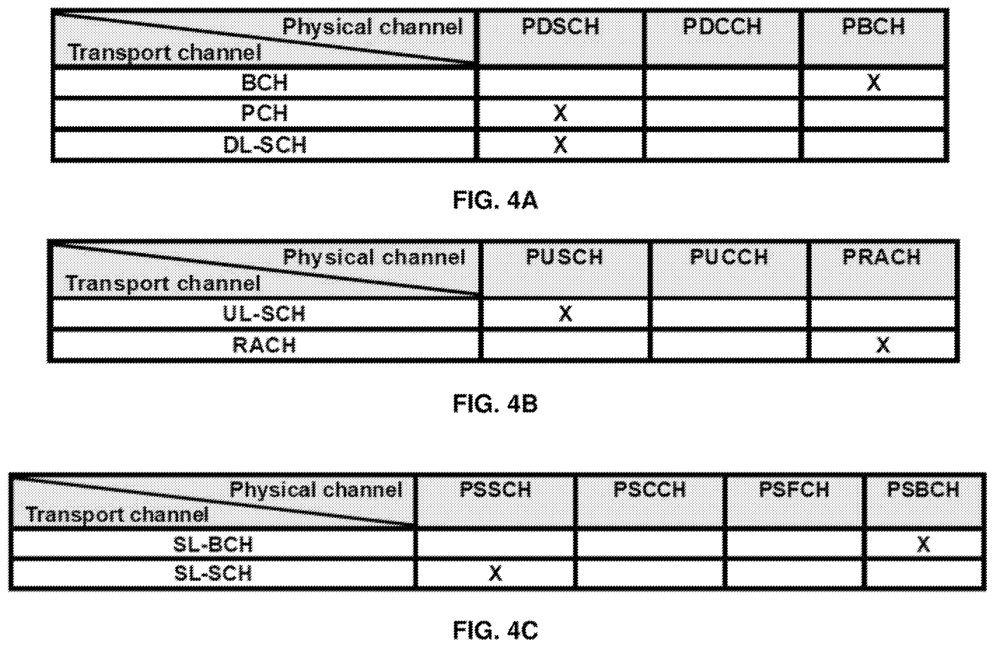

FIG. 4A, FIG. 4B and FIG. 4C show example mappings between transport channels and physical channels in downlink, uplink and sidelink, respectively, according to some aspects of some of various exemplary embodiments of the present disclosure. The physical channels in downlink include Physical Downlink Shared Channel (PDSCH), Physical Downlink Control Channel (PDCCH) and Physical Broadcast Channel (PBCH). The PCH and DL-SCH transport channels are mapped to the PDSCH. The BCH transport channel is mapped to the PBCH. A transport channel is not mapped to the PDCCH but Downlink Control Information (DCI) is transmitted via the PDCCH.

The physical channels in the uplink include Physical Uplink Shared Channel (PUSCH), Physical Uplink Control Channel (PUCCH) and Physical Random Access Channel (PRACH). The UL-SCH transport channel may be mapped to the PUSCH and the RACH transport channel may be mapped to the PRACH. A transport channel is not mapped to the PUCCH but Uplink Control Information (UCI) is transmitted via the PUCCH.

The physical channels in the sidelink include Physical Sidelink Shared Channel (PSSCH), Physical Sidelink Control Channel (PSCCH), Physical Sidelink Feedback Channel (PSFCH) and Physical Sidelink Broadcast Channel (PSBCH). The Physical Sidelink Control Channel (PSCCH) may indicate resource and other transmission parameters used by a UE for PSSCH. The Physical Sidelink Shared Channel (PSSCH) may transmit the TBs of data themselves, and control information for HARQ procedures and CSI feedback triggers, etc. At least 6 OFDM symbols within a slot may be used for PSSCH transmission. Physical Sidelink Feedback Channel (PSFCH) may carry the HARQ feedback over the sidelink from a UE which is an intended recipient of a PSSCH transmission to the UE which performed the transmission. PSFCH sequence may be transmitted in one PRB repeated over two OFDM symbols near the end of the sidelink resource in a slot. The SL-SCH transport channel may be mapped to the PSSCH. The SL-BCH may be mapped to PSBCH. No transport channel is mapped to the PSFCH but Sidelink Feedback Control Information (SFCI) may be mapped to the PSFCH. No transport channel is mapped to PSCCH but Sidelink Control Information (SCI) may mapped to the PSCCH.

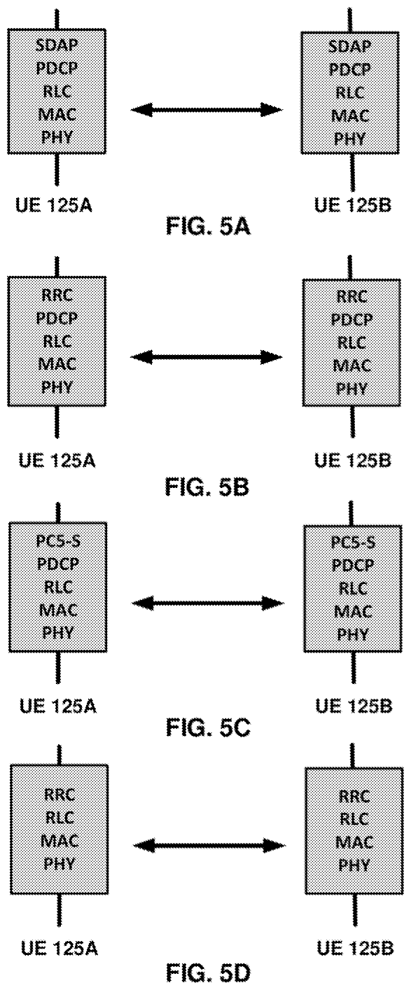

FIG. 5A, FIG. 5B, FIG. 5C and FIG. 5D show examples of radio protocol stacks for NR sidelink communication according to some aspects of some of various exemplary embodiments of the present disclosure. The AS protocol stack for user plane in the PC5 interface (i.e., for STCH) may consist of SDAP, PDCP, RLC and MAC sublayers, and the physical layer. The protocol stack of user plane is shown in FIG. 5A. The AS protocol stack for SBCCH in the PC5 interface may consist of RRC, RLC, MAC sublayers, and the physical layer as shown below in FIG. 5B. For support of PC5-S protocol, PC5-S is located on top of PDCP, RLC and MAC sublayers, and the physical layer in the control plane protocol stack for SCCH for PC5-S, as shown in FIG. 5C. The AS protocol stack for the control plane for SCCH for RRC in the PC5 interface consists of RRC, PDCP, RLC and MAC sublayers, and the physical layer. The protocol stack of control plane for SCCH for RRC is shown in FIG. 5D.

The Sidelink Radio Bearers (SLRBs) may be categorized into two groups: Sidelink Data Radio Bearers (SL DRB) for user plane data and Sidelink Signaling Radio Bearers (SL SRB) for control plane data. Separate SL SRBs using different SCCHs may be configured for PC5-RRC and PC5-S signaling, respectively.

The MAC sublayer may provide the following services and functions over the PC5 interface: Radio resource selection; Packet filtering; Priority handling between uplink and sidelink transmissions for a given UE; and Sidelink CSI reporting. With logical channel prioritization restrictions in MAC, only sidelink logical channels belonging to the same destination may be multiplexed into a MAC PDU for every unicast, groupcast and broadcast transmission which may be associated to the destination. For packet filtering, a SL-SCH MAC header including portions of both Source Layer-2 ID and a Destination Layer-2 ID may be added to a MAC PDU. The Logical Channel Identifier (LCID) included within a MAC subheader may uniquely identify a logical channel within the scope of the Source Layer-2 ID and Destination Layer-2 ID combination.

The services and functions of the RLC sublayer may be supported for sidelink. Both RLC Unacknowledged Mode (UM) and Acknowledged Mode (AM) may be used in unicast transmission while only UM may be used in groupcast or broadcast transmission. For UM, only unidirectional transmission may be supported for groupcast and broadcast.

The services and functions of the PDCP sublayer for the Uu interface may be supported for sidelink with some restrictions: Out-of-order delivery may be supported only for unicast transmission; and Duplication may not be supported over the PC5 interface.

The SDAP sublayer may provide the following service and function over the PC5 interface: Mapping between a QoS flow and a sidelink data radio bearer. There may be one SDAP entity per destination for one of unicast, groupcast and broadcast which is associated to the destination.

The RRC sublayer may provide the following services and functions over the PC5 interface: Transfer of a PC5-RRC message between peer UEs; Maintenance and release of a PC5-RRC connection between two UEs; and Detection of sidelink radio link failure for a PC5-RRC connection based on indication from MAC or RLC. A PC5-RRC connection may be a logical connection between two UEs for a pair of Source and Destination Layer-2 IDs which may be considered to be established after a corresponding PC5 unicast link is established. There may be one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages may be used for a UE to transfer UE capability and sidelink configuration including SL-DRB configuration to the peer UE. Both peer UEs may exchange their own UE capability and sidelink configuration using separate bi-directional procedures in both sidelink directions.

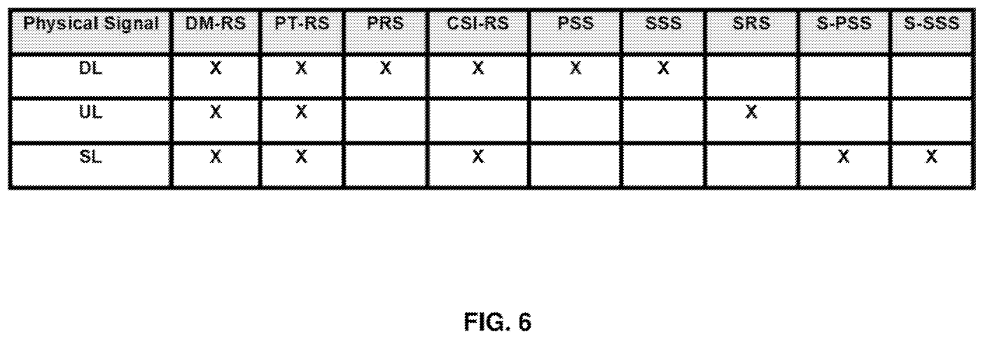

FIG. 6 shows example physical signals in downlink, uplink and sidelink according to some aspects of some of various exemplary embodiments of the present disclosure. The Demodulation Reference Signal (DM-RS) may be used in downlink, uplink and sidelink and may be used for channel estimation. DM-RS is a UE-specific reference signal and may be transmitted together with a physical channel in downlink, uplink or sidelink and may be used for channel estimation and coherent detection of the physical channel. The Phase Tracking Reference Signal (PT-RS) may be used in downlink, uplink and sidelink and may be used for tracking the phase and mitigating the performance loss due to phase noise. The PT-RS may be used mainly to estimate and minimize the effect of Common Phase Error (CPE) on system performance. Due to the phase noise properties, PT-RS signal may have a low density in the frequency domain and a high density in the time domain. PT-RS may occur in combination with DM-RS and when the network has configured PT-RS to be present. The Positioning Reference Signal (PRS) may be used in downlink for positioning using different positioning techniques. PRS may be used to measure the delays of the downlink transmissions by correlating the received signal from the base station with a local replica in the receiver. The Channel State Information Reference Signal (CSI-RS) may be used in downlink and sidelink. CSI-RS may be used for channel state estimation, Reference Signal Received Power (RSRP) measurement for mobility and beam management, time/frequency tracking for demodulation among other uses. CSI-RS may be configured UE-specifically but multiple users may share the same CSI-RS resource. The UE may determine CSI reports and transit them in the uplink to the base station using PUCCH or PUSCH. The CSI report may be carried in a sidelink MAC CE. The Primary Synchronization Signal (PSS) and the Secondary Synchronization Signal (SSS) may be used for radio fame synchronization. The PSS and SSS may be used for the cell search procedure during the initial attach or for mobility purposes. The Sounding Reference Signal (SRS) may be used in uplink for uplink channel estimation. Similar to CSI-RS, the SRS may serve as QCL reference for other physical channels such that they can be configured and transmitted quasi-collocated with SRS. The Sidelink PSS (S-PSS) and Sidelink SSS (S-SSS) may be used in sidelink for sidelink synchronization.

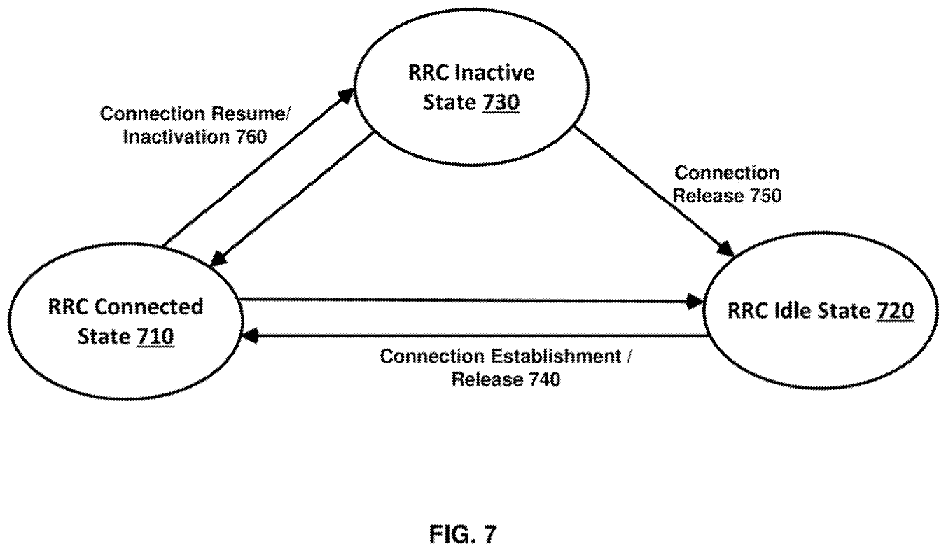

FIG. 7 shows examples of Radio Resource Control (RRC) states and transitioning between different RRC states according to some aspects of some of various exemplary embodiments of the present disclosure. A UE may be in one of three RRC states: RRC Connected State 710, RRC Idle State 720 and RRC Inactive state 730. After power up, the UE may be in RRC Idle state 720 and the UE may establish connection with the network using initial access and via an RRC connection establishment procedure to perform data transfer and/or to make/receive voice calls. Once RRC connection is established, the UE may be in RRC Connected State 710. The U E may transition from the RRC Idle state 720 to the RRC connected state 710 or from the RRC Connected State 710 to the RRC Idle state 720 using the RRC connection Establishment/Release procedures 740.

To reduce the signaling load and the latency resulting from frequent transitioning from the RRC Connected State 710 to the RRC Idle State 720 when the UE transmits frequent small data, the RRC Inactive State 730 may be used. In the RRC Inactive State 730, the AS context may be stored by both UE and gNB. This may result in faster state transition from the RRC Inactive State 730 to RRC Connected State 710. The UE may transition from the RRC Inactive State 730 to the RRC Connected State 710 or from the RRC Connected State 710 to the RRC Inactive State 730 using the RRC Connection Resume/Inactivation procedures 760. The UE may transition from the RRC Inactive State 730 to RRC Idle State 720 using an RRC Connection Release procedure 750.

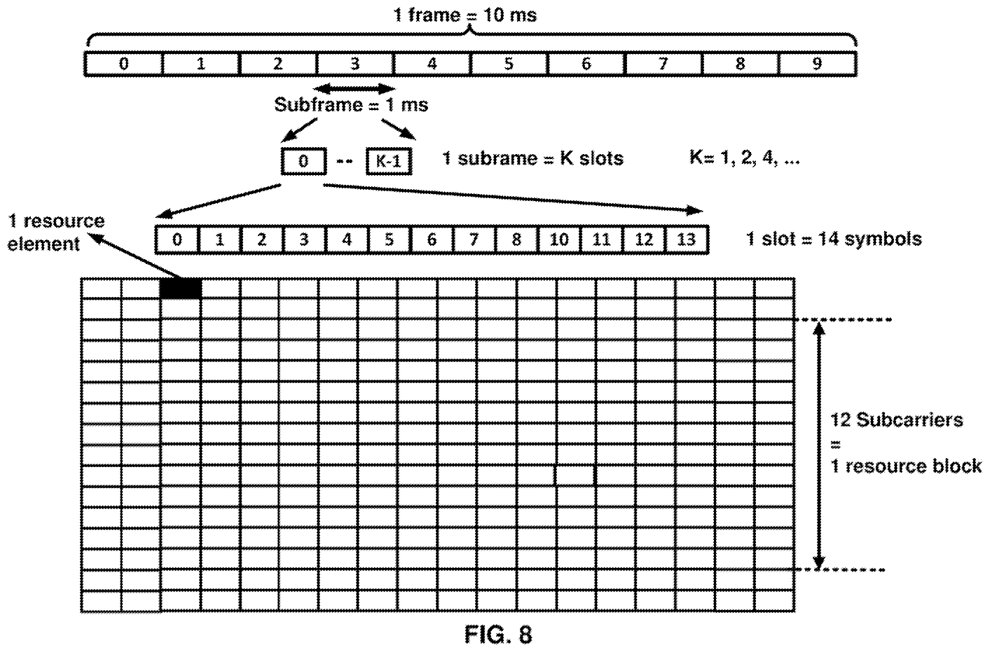

FIG. 8 shows example frame structure and physical resources according to some aspects of some of various exemplary embodiments of the present disclosure. The downlink or uplink or sidelink transmissions may be organized into frames with 10 ms duration, consisting of ten 1 ms subframes. Each subframe may consist of 1, 2, 4, . . . slots, wherein the number of slots per subframe may depend on the subcarrier spacing of the carrier on which the transmission takes place. The slot duration may be 14 symbols with Normal Cyclic Prefix (CP) and 12 symbols with Extended CP and may scale in time as a function of the used sub-carrier spacing so that there is an integer number of slots in a subframe. FIG. 8 shows a resource grid in time and frequency domain. Each element of the resource grid, comprising one symbol in time and one subcarrier in frequency, is referred to as a Resource Element (RE). A Resource Block (RB) may be defined as 12 consecutive subcarriers in the frequency domain.

In some examples and with non-slot-based scheduling, the transmission of a packet may occur over a portion of a slot, for example during 2, 4 or 7 OFDM symbols which may also be referred to as mini-slots. The mini-slots may be used for low latency applications such as URLLC and operation in unlicensed bands. In some embodiments, the mini-slots may also be used for fast flexible scheduling of services (e.g., pre-emption of URLLC over eMBB).

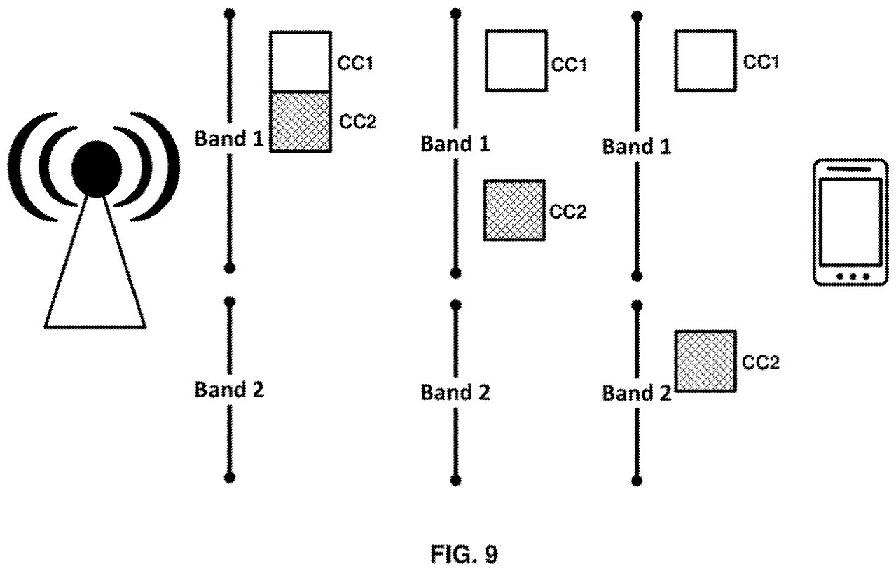

FIG. 9 shows example component carrier configurations in different carrier aggregation scenarios according to some aspects of some of various exemplary embodiments of the present disclosure. In Carrier Aggregation (CA), two or more Component Carriers (CCs) may be aggregated. A UE may simultaneously receive or transmit on one or multiple CCs depending on its capabilities. CA may be supported for both contiguous and non-contiguous CCs in the same band or on different bands as shown in FIG. 9. A gNB and the UE may communicate using a serving cell. A serving cell may be associated at least with one downlink CC (e.g., may be associated only with one downlink CC or may be associated with a downlink CC and an uplink CC). A serving cell may be a Primary Cell (PCell) or a Secondary cCell (SCell).

A UE may adjust the timing of its uplink transmissions using an uplink timing control procedure. A Timing Advance (TA) may be used to adjust the uplink frame timing relative to the downlink frame timing. The gNB may determine the desired Timing Advance setting and provides that to the UE. The UE may use the provided TA to determine its uplink transmit timing relative to the UE's observed downlink receive timing.

In the RRC Connected state, the gNB may be responsible for maintaining the timing advance to keep the L1 synchronized. Serving cells having uplink to which the same timing advance applies and using the same timing reference cell are grouped in a Timing Advance Group (TAG). A TAG may contain at least one serving cell with configured uplink. The mapping of a serving cell to a TAG may be configured by RRC. For the primary TAG, the UE may use the PCell as timing reference cell, except with shared spectrum channel access where an SCell may also be used as timing reference cell in certain cases. In a secondary TAG, the UE may use any of the activated SCells of this TAG as a timing reference cell and may not change it unless necessary.

Timing advance updates may be signaled by the gNB to the UE via MAC CE commands. Such commands may restart a TAG-specific timer which may indicate whether the L1 can be synchronized or not: when the timer is running, the L1 may be considered synchronized, otherwise, the L1 may be considered non-synchronized (in which case uplink transmission may only take place on PRACH).

A UE with single timing advance capability for CA may simultaneously receive and/or transmit on multiple CCs corresponding to multiple serving cells sharing the same timing advance (multiple serving cells grouped in one TAG). A UE with multiple timing advance capability for CA may simultaneously receive and/or transmit on multiple CCs corresponding to multiple serving cells with different timing advances (multiple serving cells grouped in multiple TAGs). The NG-RAN may ensure that each TAG contains at least one serving cell. A non-CA capable UE may receive on a single CC and may transmit on a single CC corresponding to one serving cell only (one serving cell in one TAG).

The multi-carrier nature of the physical layer in case of CA may be exposed to the MAC layer and one HARQ entity may be required per serving cell. When CA is configured, the UE may have one RRC connection with the network. At RRC connection establishment/re-establishment/handover, one serving cell (e.g., the PCell) may provide the NAS mobility information. Depending on UE capabilities, SCells may be configured to form together with the PCell a set of serving cells. The configured set of serving cells for a UE may consist of one PCell and one or more SCells. The reconfiguration, addition and removal of SCells may be performed by RRC.

In a dual connectivity scenario, a UE may be configured with a plurality of cells comprising a Master Cell Group (MCG) for communications with a master base station, a Secondary Cell Group (SCG) for communications with a secondary base station, and two MAC entities: one MAC entity and for the MCG for communications with the master base station and one MAC entity for the SCG for communications with the secondary base station.

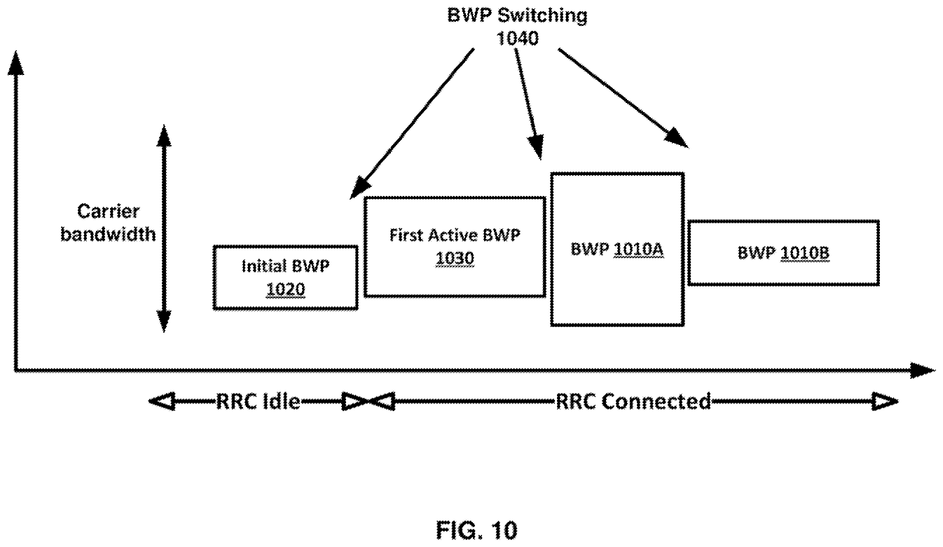

FIG. 10 shows example bandwidth part configuration and switching according to some aspects of some of various exemplary embodiments of the present disclosure. The UE may be configured with one or more Bandwidth Parts (BWPs) 1010 on a given component carrier. In some examples, one of the one or more bandwidth parts may be active at a time. The active bandwidth part may define the UE's operating bandwidth within the cell's operating bandwidth. For initial access, and until the UE's configuration in a cell is received, initial bandwidth part 1020 determined from system information may be used. With Bandwidth Adaptation (BA), for example through BWP switching 1040, the receive and transmit bandwidth of a UE may not be as large as the bandwidth of the cell and may be adjusted. For example, the width may be ordered to change (e.g. to shrink during period of low activity to save power); the location may move in the frequency domain (e.g. to increase scheduling flexibility); and the subcarrier spacing may be ordered to change (e.g. to allow different services). The first active BWP 1020 may be the active BWP upon RRC (re-)configuration for a PCell or activation of an SCell.

For a downlink BWP or uplink BWP in a set of downlink BWPs or uplink BWPs, respectively, the UE may be provided the following configuration parameters: a Subcarrier Spacing (SCS); a cyclic prefix; a common RB and a number of contiguous RBs; an index in the set of downlink BWPs or uplink BWPs by respective BWP-Id; a set of BWP-common and a set of BWP-dedicated parameters. A BWP may be associated with an OFDM numerology according to the configured subcarrier spacing and cyclic prefix for the BWP. For a serving cell, a UE may be provided by a default downlink BWP among the configured downlink BWPs. If a UE is not provided a default downlink BWP, the default downlink BWP may be the initial downlink BWP.

A downlink BWP may be associated with a BWP inactivity timer. If the BWP inactivity timer associated with the active downlink BWP expires and if the default downlink BWP is configured, the UE may perform BWP switching to the default BWP. If the BWP inactivity timer associated with the active downlink BWP expires and if the default downlink BWP is not configured, the UE may perform BWP switching to the initial downlink BWP.

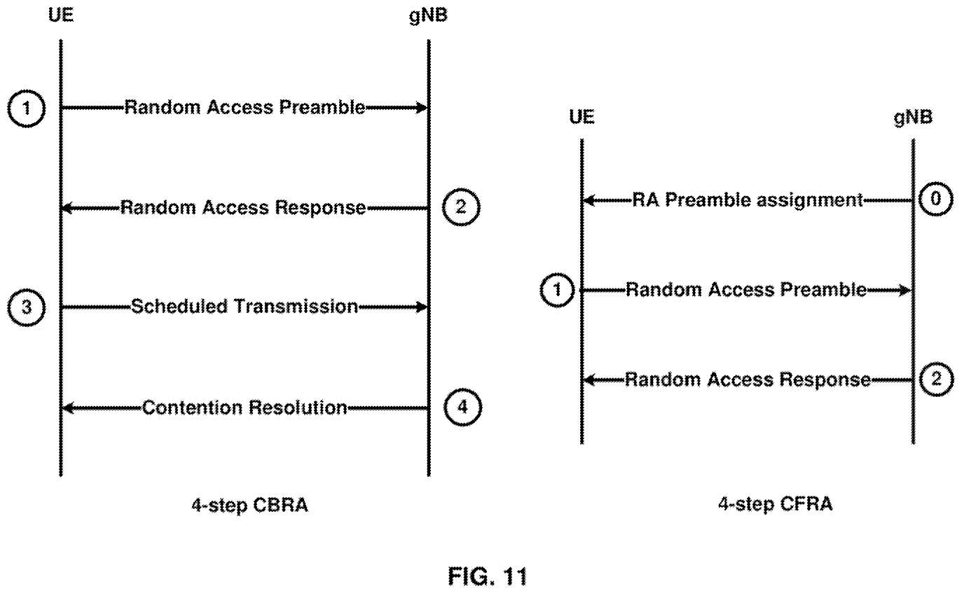

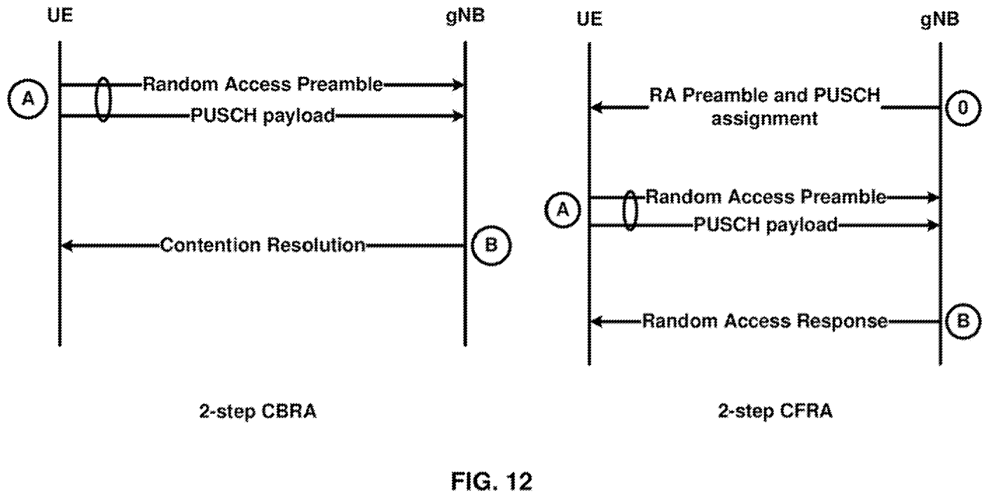

FIG. 11 shows example four-step contention-based and contention-free random access processes according to some aspects of some of various exemplary embodiments of the present disclosure. FIG. 12 shows example two-step contention-based and contention-free random access processes according to some aspects of some of various exemplary embodiments of the present disclosure. The random access procedure may be triggered by a number of events, for example: Initial access from RRC Idle State; RRC Connection Re-establishment procedure; downlink or uplink data arrival during RRC Connected State when uplink synchronization status is “non-synchronized”; uplink data arrival during RRC Connected State when there are no PUCCH resources for Scheduling Request (SR) available; SR failure; Request by RRC upon synchronous reconfiguration (e.g. handover); Transition from RRC Inactive State; to establish time alignment for a secondary TAG; Request for Other System Information (SI); Beam Failure Recovery (BFR); Consistent uplink Listen-Before-Talk (LBT) failure on PCell.

Two types of Random Access (RA) procedure may be supported: 4-step RA type with MSG1 and 2-step RA type with MSGA. Both types of RA procedure may support Contention-Based Random Access (CBRA) and Contention-Free Random Access (CFRA) as shown in FIG. 11 and FIG. 12.

The UE may select the type of random access at initiation of the random access procedure based on network configuration. When CFRA resources are not configured, a RSRP threshold may be used by the UE to select between 2-step RA type and 4-step RA type. When CFRA resources for 4-step RA type are configured, UE may perform random access with 4-step RA type. When CFRA resources for 2-step RA type are configured, UE may perform random access with 2-step RA type.

The MSG1 of the 4-step RA type may consist of a preamble on PRACH. After MSG1 transmission, the UE may monitor for a response from the network within a configured window. For CFRA, dedicated preamble for MSG1 transmission may be assigned by the network and upon receiving Random Access Response (RAR) from the network, the UE may end the random access procedure as shown in FIG. 11. For CBRA, upon reception of the random access response, the UE may send MSG3 using the uplink grant scheduled in the random access response and may monitor contention resolution as shown in FIG. 11. If contention resolution is not successful after MSG3 (re)transmission(s), the UE may go back to MSG1 transmission.

The MSGA of the 2-step RA type may include a preamble on PRACH and a payload on PUSCH. After MSGA transmission, the UE may monitor for a response from the network within a configured window. For CFRA, dedicated preamble and PUSCH resource may be configured for MSGA transmission and upon receiving the network response, the UE may end the random access procedure as shown in FIG. 12. For CBRA, if contention resolution is successful upon receiving the network response, the UE may end the random access procedure as shown in FIG. 12; while if fallback indication is received in MSGB, the UE may perform MSG3 transmission using the uplink grant scheduled in the fallback indication and may monitor contention resolution. If contention resolution is not successful after MSG3 (re)transmission(s), the UE may go back to MSGA transmission.

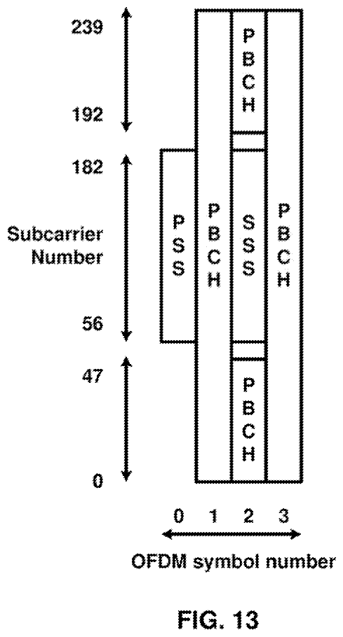

FIG. 13 shows example time and frequency structure of Synchronization Signal and Physical Broadcast Channel (PBCH) Block (SSB) according to some aspects of some of various exemplary embodiments of the present disclosure. The SS/PBCH Block (SSB) may consist of Primary and Secondary Synchronization Signals (PSS, SSS), each occupying 1 symbol and 127 subcarriers (e.g., subcarrier numbers 56 to 182 in FIG. 13), and PBCH spanning across 3 OFDM symbols and 240 subcarriers, but on one symbol leaving an unused part in the middle for SSS as show in FIG. 13. The possible time locations of SSBs within a half-frame may be determined by sub-carrier spacing and the periodicity of the half-frames, where SSBs are transmitted, may be configured by the network. During a half-frame, different SSBs may be transmitted in different spatial directions (i.e., using different beams, spanning the coverage area of a cell).

The PBCH may be used to carry Master Information Block (MIB) used by a UE during cell search and initial access procedures. The UE may first decode PBCH/MIB to receive other system information. The MIB may provide the UE with parameters required to acquire System Information Block 1 (SIB1), more specifically, information required for monitoring of PDCCH for scheduling PDSCH that carries SIB1. In addition, MIB may indicate cell barred status information. The MIB and SIB1 may be collectively referred to as the minimum system information (SI) and SIB1 may be referred to as remaining minimum system information (RMSI). The other system information blocks (SIBs) (e.g., SIB2, SIB3, . . . , SIB10 and SIBpos) may be referred to as Other SI. The Other SI may be periodically broadcast on DL-SCH, broadcast on-demand on DL-SCH (e.g., upon request from UEs in RRC Idle State, RRC Inactive State, or RRC connected State), or sent in a dedicated manner on DL-SCH to UEs in RRC Connected State (e.g., upon request, if configured by the network, from UEs in RRC Connected State or when the UE has an active BWP with no common search space configured).

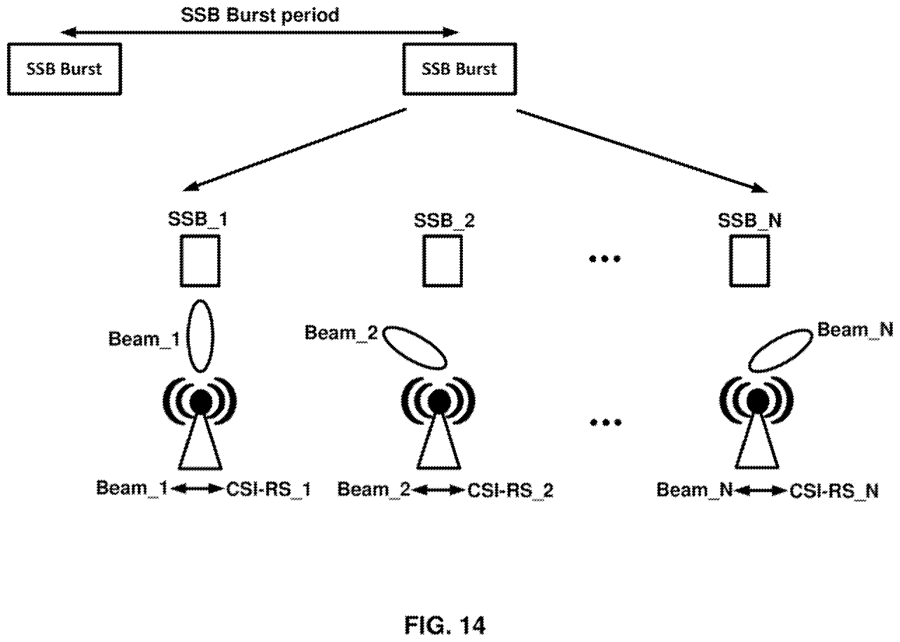

FIG. 14 shows example SSB burst transmissions according to some aspects of some of various exemplary embodiments of the present disclosure. An SSB burst may include N SSBs and each SSB of the N SSBs may correspond to a beam. The SSB bursts may be transmitted according to a periodicity (e.g., SSB burst period). During a contention-based random access process, a UE may perform a random access resource selection process, wherein the UE first selects an SSB before selecting a RA preamble. The U E may select an SSB with an RSRP above a configured threshold value. In some embodiments, the UE may select any SSB if no SSB with RSRP above the configured threshold is available. A set of random access preambles may be associated with an SSB. After selecting an SSB, the UE may select a random access preamble from the set of random access preambles associated with the SSB and may transmit the selected random access preamble to start the random access process.

In some embodiments, a beam of the N beams may be associated with a CSI-RS resource. A UE may measure CSI-RS resources and may select a CSI-RS with RSRP above a configured threshold value. The UE may select a random access preamble corresponding to the selected CSI-RS and may transmit the selected random access process to start the random access process. If there is no random access preamble associated with the selected CSI-RS, the UE may select a random access preamble corresponding to an SSB which is Quasi-Collocated with the selected CSI-RS.

In some embodiments, based on the UE measurements of the CSI-RS resources and the UE CSI reporting, the base station may determine a Transmission Configuration Indication (TCI) state and may indicate the TC state to the UE, wherein the UE may use the indicated TCI state for reception of downlink control information (e.g., via PDCCH) or data (e.g., via PDSCH). The UE may use the indicated TCI state for using the appropriate beam for reception of data or control information. The indication of the TCI states may be using RRC configuration or in combination of RRC signaling and dynamic signaling (e.g., via a MAC Control element (MAC CE) and/or based on a value of field in the downlink control information that schedules the downlink transmission). The TCI state may indicate a Quasi-Colocation (QCL) relationship between a downlink reference signal such as CSI-RS and the DM-RS associated with the downlink control or data channels (e.g., PDCCH or PDSCH, respectively).

In some embodiments, the UE may be configured with a list of up to M TCI-State configurations, using Physical Downlink Shared Channel (PDSCH) configuration parameters, to decode PDSCH according to a detected PDCCH with DCI intended for the UE and the given serving cell, where M may depends on the UE capability. Each TCI-State may contain parameters for configuring a QCL relationship between one or two downlink reference signals and the DM-RS ports of the PDSCH, the DM-RS port of PDCCH or the CSI-RS port(s) of a CSI-RS resource. The quasi co-location relationship may be configured by one or more RRC parameters. The quasi co-location types corresponding to each DL RS may take one of the following values: ‘QCL-TypeA’: {Doppler shift, Doppler spread, average delay, delay spread}; ‘QCL-TypeB’: {Doppler shift, Doppler spread}; ‘QCL-TypeC’: {Doppler shift, average delay}; ‘QCL-TypeD’: {Spatial Rx parameter}. The UE may receive an activation command (e.g., a MAC CE), used to map TCI states to the codepoints of a DCI field.

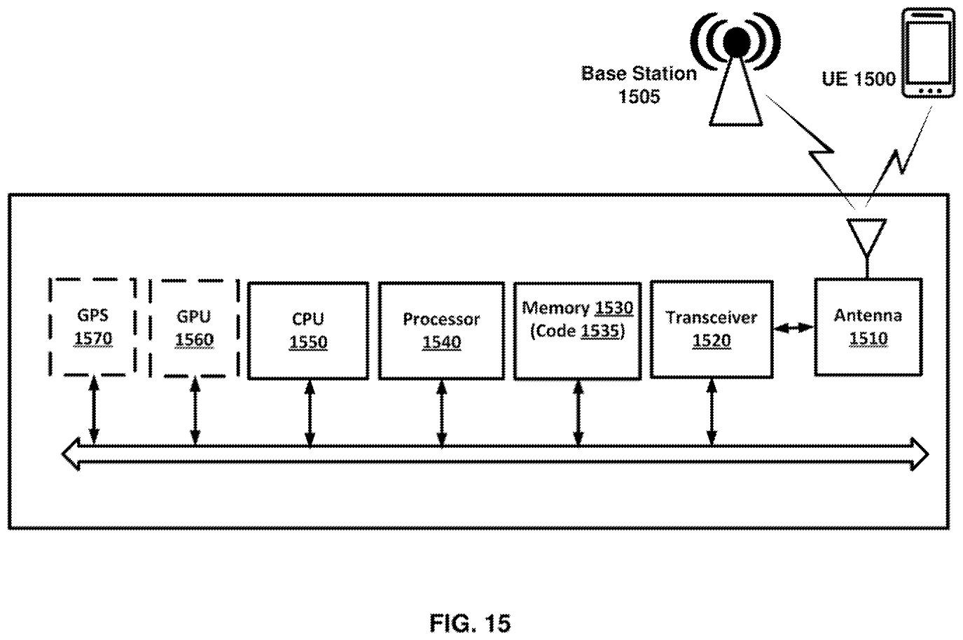

FIG. 15 shows example components of a user equipment and a base station for transmission and/or reception according to some aspects of some of various exemplary embodiments of the present disclosure. All or a subset of blocks and functions in FIG. 15 may be in the base station 1505 and the user equipment 1500 and may be performed by the user equipment 1500 and by the base station 1505. The Antenna 1510 may be used for transmission or reception of electromagnetic signals. The Antenna 1510 may comprise one or more antenna elements and may enable different input-output antenna configurations including Multiple-Input Multiple Output (MIMO) configuration, Multiple-Input Single-Output (MISO) configuration and Single-Input Multiple-Output (SIMO) configuration. In some embodiments, the Antenna 150 may enable a massive MIMO configuration with tens or hundreds of antenna elements. The Antenna 1510 may enable other multi-antenna techniques such as beamforming. In some examples and depending on the UE 1500 capabilities or the type of UE 1500 (e.g., a low-complexity UE), the UE 1500 may support a single antenna only.

The transceiver 1520 may communicate bi-directionally, via the Antenna 1510, wireless links as described herein. For example, the transceiver 1520 may represent a wireless transceiver at the UE and may communicate bi-directionally with the wireless transceiver at the base station or vice versa. The transceiver 1520 may include a modem to modulate the packets and provide the modulated packets to the Antennas 1510 for transmission, and to demodulate packets received from the Antennas 1510.

The memory 1530 may include RAM and ROM. The memory 1530 may store computer-readable, computer-executable code 1535 including instructions that, when executed, cause the processor to perform various functions described herein. In some examples, the memory 1530 may contain, among other things, a Basic Input/output System (BIOS) which may control basic hardware or software operation such as the interaction with peripheral components or devices.

The processor 1540 may include a hardware device with processing capability (e.g., a general purpose processor, a DSP, a CPU, a microcontroller, an ASIC, an FPGA, a programmable logic device, a discrete gate or transistor logic component, a discrete hardware component, or any combination thereof). In some examples, the processor 1540 may be configured to operate a memory using a memory controller. In other examples, a memory controller may be integrated into the processor 1540. The processor 1540 may be configured to execute computer-readable instructions stored in a memory (e.g., the memory 1530) to cause the UE 1500 or the base station 1505 to perform various functions.

The Central Processing Unit (CPU) 1550 may perform basic arithmetic, logic, controlling, and Input/output (I/O) operations specified by the computer instructions in the Memory 1530. The user equipment 1500 and/or the base station 1505 may include additional peripheral components such as a graphics processing unit (GPU) 1560 and a Global Positioning System (GPS) 1570. The GPU 1560 is a specialized circuitry for rapid manipulation and altering of the Memory 1530 for accelerating the processing performance of the user equipment 1500 and/or the base station 1505. The GPS 1570 may be used for enabling location-based services or other services for example based on geographical position of the user equipment 1500.

In some examples, multicast and broadcast services (MBS) may be enabled via single-cell transmission. MBS may be transmitted in the coverage of a single cell. One or more Multicast/Broadcast control channels (e.g., MCCHs) and one or more Multicast/Broadcast data channels (e.g., MTCHs) may be mapped on DL-SCH. The scheduling may be done by the gNB. The Multicast/Broadcast control channel and the Multicast/Broadcast data channel transmissions may be indicated by a logical channel specific RNTI on PDCCH. In some examples, a one-to-one mapping between a service identifier such as a temporary mobile group identifier (TMGI) and a RAN level identifier such as a group identifier (G-RNTI) may be used for the reception of the DL-SCH to which a Multicast/Broadcast data channel may be mapped. In some examples, a single transmission may be used for DL-SCH associated with the Multicast/Broadcast control channel and/or the Multicast/Broadcast data channel transmissions and HARQ or RLC retransmissions may not be used and/or an RLC Unacknowledged Mode (RLC UM) may be used. In other examples some feedback (e.g., HARQ feedback or RLC feedback) may be used for transmissions via Multicast/Broadcast control channel and/or Multicast/Broadcast data channels.

In some example, for Multicast/Broadcast data channel, the following scheduling information may be provided on Multicast/Broadcast control channel: a Multicast/Broadcast data channel scheduling cycle, a Multicast/Broadcast data channel on-duration (e.g., duration that the UE waits for, after waking up from DRX, to receive PDCCHs), a Multicast/Broadcast data channel inactivity timer (e.g., duration that the UE waits to successfully decode a PDCCH, from the last successful decoding of a PDCCH indicating the DL-SCH to which this Multicast/Broadcast data channel is mapped, failing which it re-enters DRX).

In some examples, one or more UE identities may be related to multicast and broadcast services (MBS)transmissions. The one or more identities may comprise at least one of: one or more first RNTIs that identify transmissions of the Multicast/Broadcast control channel; one or more second RNTIs that identify transmissions of a Multicast/Broadcast data channels. The one or more first RNTIs that identify transmissions of the Multicast/Broadcast control channel may comprise a single cell RNTI (SC-RNTI, other names may be used). The one or more second RNTIs that identify transmissions of a Multicast/Broadcast data channels may comprise a G-RNTI (nG-RNTI or other names may be used).

In some examples, one or more logical channels may be related to MBS transmissions. The one or more logical channels may comprise a Multicast/Broadcast control channel. The Multicast/Broadcast control channel may be a point-to-multipoint downlink channel used for transmitting MBS control information from the network to the UE, for one or several Multicast/Broadcast data channel. This channel may be used by UEs that receive or are interested to receive MBS. The one or more logical channels may comprise a Multicast/Broadcast data channel. This channel may be a point-to-multipoint downlink channel for transmitting MBS traffic data from the network.

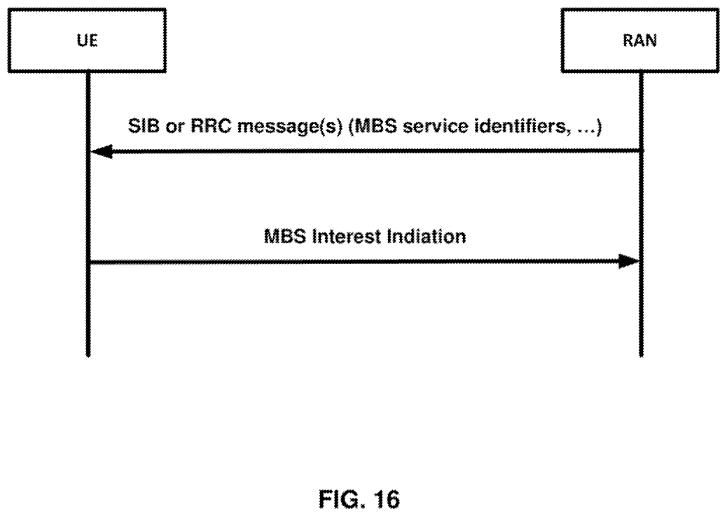

In some examples, a procedure may be used by the UE to inform RAN that the UE is receiving or is interested to receive MBS service(s) via an MBS radio bearer, and if so, to inform the 5G RAN about the priority of MBS versus unicast reception or MBS service(s) reception in receive only mode. An example is shown in FIG. 16. The UE may transmit a message (e.g., an MBS interest indication message) message to inform RAN that the U E is receiving/interested to receive or no longer receiving/interested to receive MBS service(s). The UE may transmit the message based on receiving one or more messages (e.g., a SIB message or a unicast RRC message) from the network for example indicating one or more MBS Service Area Identifiers of the current and/or neighboring carrier frequencies.

In some examples, the UE may consider an MBS service to be part of the MBS services of interest if the UE is capable of receiving MBS services (e.g., via a single cell point to multipoint mechanism); and/or the UE is receiving or interested to receive this service via a bearer associated with MBS services; and/or one session of this service is ongoing or about to start; and/or at least one of the one or more MBS service identifiers indicated by network is of interest to the UE.

In some examples, control information for reception of MBS services may be provided on a specific logical channel: (e.g., a MCCH). The MCCH may carry one or more configuration messages which indicate the MBS sessions that are ongoing as well as the (corresponding) information on when each session may be scheduled, e.g., scheduling period, scheduling window and start offset. The one or more configuration messages may provide information about the neighbor cells transmitting the MBS sessions which may be ongoing on the current cell. In some examples, the UE may receive a single MBS service at a time, or more than one MBS services in parallel.

In some examples, the MCCH information (e.g., the information transmitted in messages sent over the MCCH) may be transmitted periodically, using a configurable repetition period. The MCCH transmissions (and the associated radio resources and MCS) may be indicated on PDCCH.

In some examples, change of MCCH information may occur at specific radio frames/subframes/slots and/or a modification period may be used. For example, within a modification period, the same MCCH information may be transmitted a number of times, as defined by its scheduling (which is based on a repetition period). The modification period boundaries may be defined by SFN values for which SFN mod m=0, where m is the number of radio frames comprising the modification period. The modification period may be configured by a SIB or by RRC signaling.

In some examples, when the network changes (some of) the MCCH information, it may notify the UEs about the change in the first subframe/slot which may be used for MCCH transmission in a repetition period. Upon receiving a change notification, a UE interested to receive multicast and broadcast services (MBS) may acquire the new MCCH information starting from the same subframe/slot. The UE may apply the previously acquired MCCH information until the UE acquires the new MCCH information.

In an example, a system information block (SIB) may contain the information required to acquire the control information associated transmission of MBS. The information may comprise at least one of: one or more discontinuous reception (DRX) parameters for monitoring for scheduling information of the control information associated transmission of MBS, scheduling periodicity and offset for scheduling information of the control information associated transmission of MBS, modification period for modification of content of the control information associated transmission of MBS, repetition information for repetition of the control information associated transmission of MBS, etc.

In an example, an information element (IE) may provide configuration parameters indicating, for example, the list of ongoing MBS sessions transmitted via one or more bearers for each MBS session, one or more associated RNTIs (e.g., G-RNTI, other names may be used) and scheduling information. The configuration parameters may comprise at least one of: one or more timer values for discontinuous reception (DRX) (e.g., an inactivity timer or an On Duration timer), an RNTI for scrambling the scheduling and transmission of a Multicast/Broadcast traffic channel (e.g., MTCH, other names may be used), ongoing MBS session, one or more power control parameters, one or more scheduling periodicity and/or offset values for one or more MBS traffic channels, information about list of neighbor cells, etc.

In some examples, immediate MDT may refer to as a minimization of drive test (MDT) functionality involving measurements performed by the UE in CONNECTED state and reporting of the measurements to RAN available at the time of reporting condition as well as measurements by the network for MDT purposes.

In some examples, logged MDT may refer to a MDT functionality involving measurement logging by UE in IDLE mode, INACTIVE state, CELL_PCH, URA_PCH states and CELL_FACH state when second DRX cycle is used (when UE is in UTRA) for reporting to eNB/RNC/gNB at a later point in time, and logging of MBSFN measurements by E-UTRA U E in IDLE and CONNECTED modes.

In some examples, management Based MDT PLMN List may indicate a MDT PLMN List applicable to management based MDT.

In some examples, MDT measurements may refer to Measurements determined for MDT.

In some examples, MDT PLMN List may refer to a list of PLMNs where MDT is allowed for a user. It may be a subset of the EPLMN list and RPLMN at the time when MDT is initiated.

In some examples, signaling based MDT PLMN List may indicate a MDT PLMN List applicable to signaling based MDT.

In some examples, the principles and requirements guiding the definition of functions for Minimization of drive tests may be as follows.

In some examples, there may be two modes for the MDT measurements: Logged MDT and Immediate MDT. There may also be cases of measurement collection not specified as either immediate or logged MDT, such as Accessibility measurements.

In some examples, it may be possible to configure MDT measurements for the UE logging purpose independently from the network configurations for normal RRM purposes. In some examples, the availability of measurement results may be conditionally dependent on the UE RRM configuration.

In some examples, UE MDT measurement logs may comprise multiple events and measurements taken over time. The time interval for measurement collection and reporting may be decoupled in order to limit the impact on the UE battery consumption and network signaling load.

In some examples, it may be possible to configure the geographical area where the defined set of measurements may be collected.

In some examples, the measurements may be linked to available location information and/or other information or measurements that may be used to derive location information.

In some examples, the measurements in measurement logs may be linked to a time stamp.

In some examples, the measurements may be linked to available sensor information that may be used to derive UE orientation in a global coordinate system, the uncompensated barometric pressure and the UE speed.

In some examples, the network may use UE capabilities to select terminals for MDT measurements.

In some examples, the solutions for MDT may take into account the following constraints. In some examples, the UE measurement logging mechanism may be an optional feature. In order to limit the impact on UE power consumption and processing, the UE measurement logging may as much as possible rely on the measurements that are available in the UE according to radio resource management enforced by the access network. In some examples, the availability of location information may be subject to UE capability and/or UE implementation. Solutions requiring location information may take into account power consumption of the UE due to the need to run its positioning components.

Multicast and broadcast services (MBS) use cases may have a wide range including such as legacy multicast broadcast multimedia services (MBMS) type broadcast services, Mission Critical Communications, Internet of Things (IoT), and Vehicle-to-everything (V2X) among others. These use cases may involve transmissions with low to very high data rates targeting from few users and up to thousands of user devices within each cell. The need for, and complexity of reliable delivery may vary by use case and deployment.

In some examples, MBS includes both multicast and broadcast mode. The multicast mode of MBS delivery may target higher QoS benefits from UE's channel feedback including HARQ and CSI feedback and possibly RRM measurement, like those used for unicast services. Existing broadcast mode of MBS delivery may not support HARQ/CSI feedback and/or RRM measurement.

In some examples, reliability of reception of Multicast and Broadcast Service (MBS) may be enhanced based on UEs' feedback. The MBS services may include a multicast mode and a broadcast mode. Existing processes for broadcast mode delivery may not support standard based measurement and feedback from the receiving UEs and therefore its configuration, in term of MCS level, HARQ auto-retransmission as well as MIMO and beamforming configuration may not be optimized based on user experiences. Example embodiments may extend the minimization of drive testing (MDT) framework to support MBS based measurements and reporting for UEs in Inactive and Idle States.

In some examples, without measurement or feedback about the quality of delivery and its reliably from UEs point of view, the MBS broadcast transmission parameters may not be set correctly resulting in unreliable delivery or excessively inefficient use of radio resources.

In some examples, an MDT framework for UEs may provide the network with location and time stamped measurement report of various QoE metrics. In some examples, immediate and logged MDT may be specified for unicast services.

In some examples, the existing rational and design of MDT framework in NR for unicast services may be enhanced to account for specific new characteristics of MBS transmission. In some examples, once the gNB receives the time and location stamped MDT data it may correlate that with MBS configurations used at those time and locations and decide of any changes needed.

In some examples, the MDT immediate and logged MDT may be supported for MBS in multicast and broadcast delivery modes.

In some examples, to provide full flexibility in getting MDT measurement to gNB for proper configuration of MBS transmission parameters that both immediate or logged MDT may be used for MBS supporting both multicast and broadcast delivery modes.

In some examples, the UE may receive multicast MBS in RRC connected state. However, it is expected that multicast reception by UEs on RRC inactive and possibly idle state will be added in or before Release 18. For broadcast mode of MBS UEs may receive the data in any RRC state.

In some examples, the UE may receive multicast MBS in RRC connected state. However, it may be expected that multicast reception by UEs on RRC inactive and possibly idle state may be added. For broadcast mode of MBS UEs may receive the data in any RRC state.

In some MBS use cases and scenarios, majority of UEs receiving MBS signaling and data may not be in connected state due to power saving for an extended period of time. Example embodiments may enable MDT measurement and reporting from UEs in Inactive and Idle state.

In some examples, MDT framework in NR may support measurement and reporting of MDT data for MBS services from UEs receiving such MBS services in inactive and idle states.

In some examples, MDT measurements and reporting signaling may allow triggering MDT measurement and reporting from UEs in all RRC states.

In some examples, the granularity of MBS related measurements and reporting with respects to services and transmission points may be enhanced. The network may configure one or more Multicast Control CHannels (MCCHs) each providing information about how to find and process one or more MTCHs. The network may offer a variety of MBS services with different time, frequency, and spatial transmission configurations. In this context, MBS services grouped and transmitted together with the same configuration and in the same Multicast Traffic CHannel (MTCH) may be referred to as an MBS bundle.

In some examples, MDT measurement, reporting and triggering may be configured and set differently for different MBS bundles.

In some examples, MDT related signaling may include configuration of measurement and triggers for reporting. Various measurements on QoE related parameters such as RSRP or BLER on MTCH or MCCH may be configurated along with reporting event criteria. Given the nature of MBS with many, and in case of broadcast unknown, number of users receiving the service, the MDT measurement and reporting configuration signaling may be provided more efficiently through some common control signaling.

In some examples, MDT measurement and reporting control signaling may allow delivery of such configuration information and its changes to UEs in all RRC states.

In some examples, MDT measurement and reporting configuration may be provided to UEs in all RRC states through common control signaling.

In some examples, MDT configuration, at least those common across all MBS bundles, may be transmitted using system information signaling as an MDT SIB similar to the Other System Information (OSI) signaling or may be included as an Information Element (IE) in the MCCH.

In some examples, MBS bundle specific MDT configuration may be included as an information element within MCCH message or may be transmitted as part MDT SIB.

In some examples, MDT triggering command IE may be signalled for select MBS bundles and may be included as an IE in the corresponding MCCH message or use MCCH update notification mechanism.

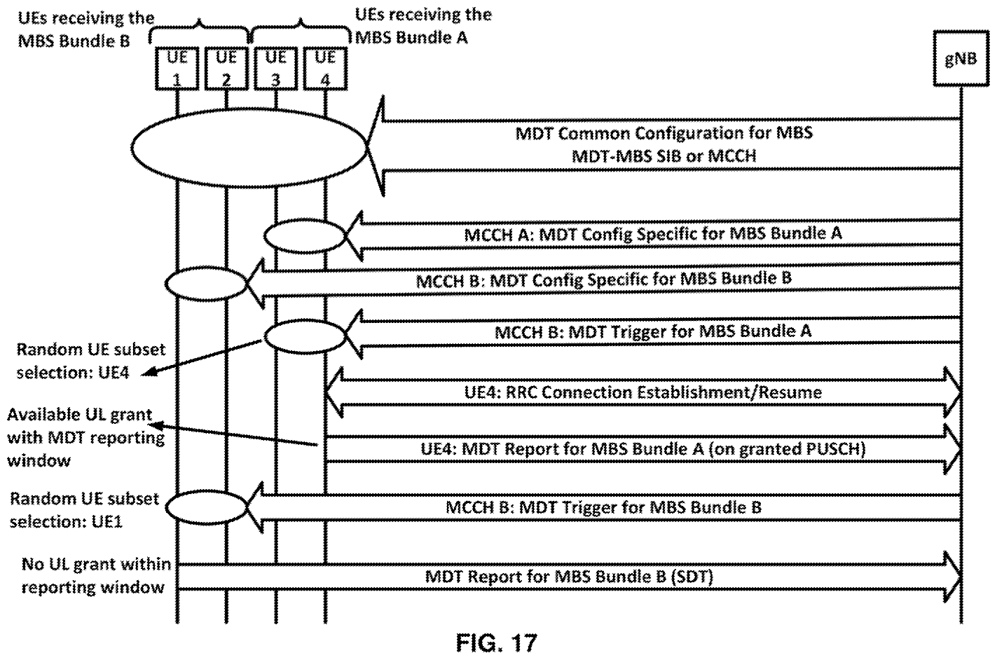

FIG. 17 shows an example of MDT configuration signaling using a combination of common/broadcast signaling for two MBS bundles.

In some examples, to limit and manage the MDT reporting overhead, a small subset of UEs who are receiving an MBS bundle may be triggered to report their MDT measurement based on network configured rules.

In some examples, MDT tracking measurements and/or reporting for an MBS bundle may be limited to certain range of RSRPs, BLERs, geolocations and may be triggered only within limited configured time windows.

In some examples, MDT configurations may include measurements thresholds/ranges and time windows, reporting trigger events and reporting time windows.

In some examples, configurable probabilistic randomization, e.g., based on UE ID, may be applied to further limit the number of users sending MBS report. In some examples, UEs who have received data on the target MBS bundle throughout the entire MDT measurement period may report.

In some examples, the common UL resource allocation for MDT reporting may allow UEs in RRC Inactive or Idle state send their MDT report without returning to RRC connected state. Such common resource may be used for reporting if UEs does not have a valid uplink grant within reporting period. The common resources allocation for MDT reporting related to MBS may be based on Small Data Transmission (SDT) capability. The SDT framework may allow Random Access (RA) or Configured Grant (CG) based small data transmission from RRC Inactive UEs without returning to RRC connected state. For example, one time MDT reporting may use RA based SDT while multiple MDT reporting may use CG based SDT.

In some examples, if configured by the network, UEs may send their MDT report on a set of common UL resources which may be RRC configured unless they have an uplink grant which may be used within MDT reporting period.

In some examples, the common uplink resource allocation for MDT reporting for MBS may reuse the SDT framework in NR to allow UEs in RRC inactive state to send their MDT measurement without returning to RRC connected states.

In some examples, if SDT is used for MDT reporting of MBS, a common set of RA or CG based resources may be configured to be used for all MBS bundles or they may be configured for each MBS bundle.

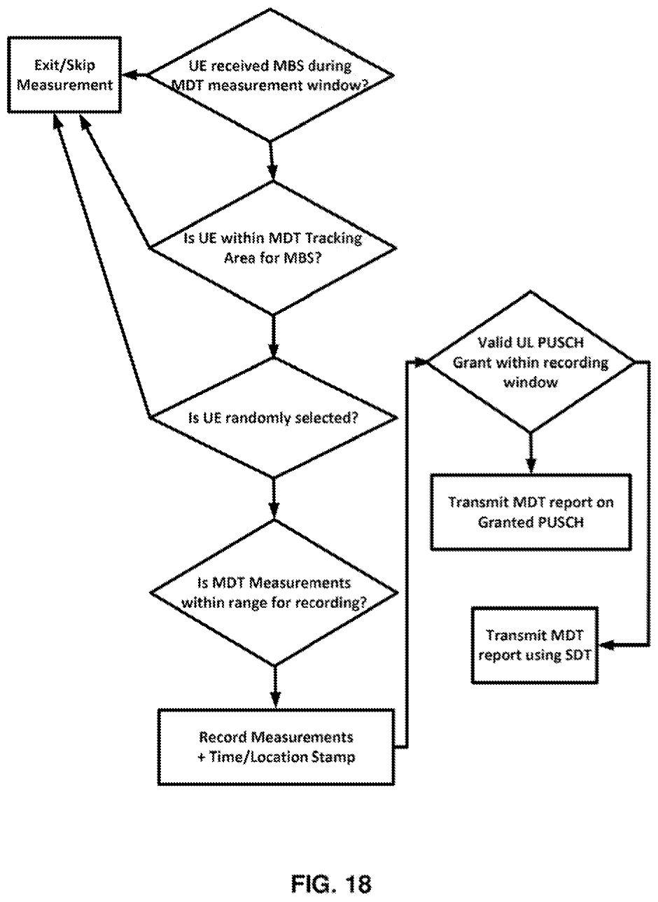

FIG. 18 shows an example of rules and considerations to limit measurement, logging and reporting of MDT data for each MBS bundle and transmission using dedicated uplink resource on a granted PUSCH or using SDT.

The MBS services may include multicast and broadcast modes. The broadcast mode delivery may not support feedback from the receiving UEs and therefore its configuration, in term of MCS level, HARQ auto-retransmission as well as MIMO and beamforming configuration may not be optimized based on user experiences. There is a need to enhance the feedback for optimization of MBS services, for example for broadcast mode of MBS and/or while in the idle/inactive state. Example embodiments enhance the reception of MBS services for example for broadcast mode of MBS and/or while in the idle/inactive state.

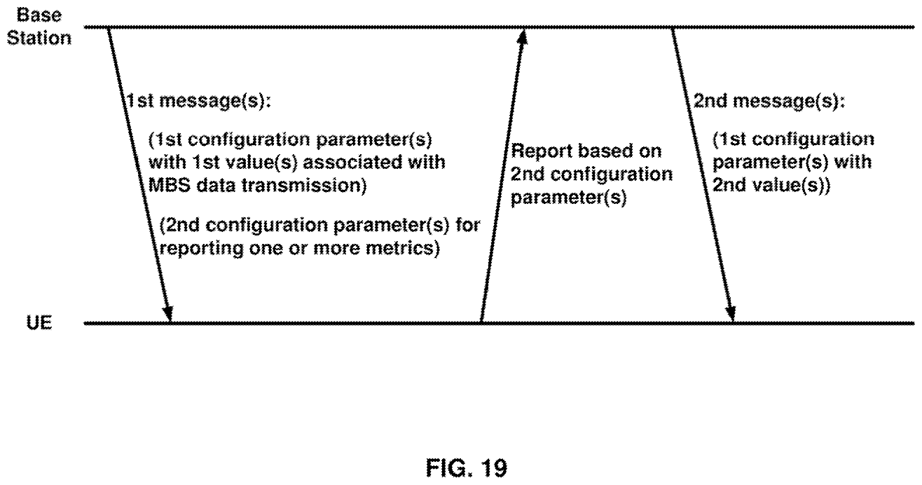

In an example embodiment as shown in FIG. 19, a UE may receive one or more first messages comprising configuration parameters. In some examples, the one or more first messages may comprise one or more RRC messages. In some examples, the one or more first messages may comprise one or more broadcast messages. In some examples, the one or more first messages may comprise one or more first configuration parameters and one or more second configuration parameters. In some examples, at least a portion of the one or more first configuration parameters may be received a broadcast message (e.g., a broadcast message comprising system information, e.g., a system information block (SIB), e.g., a SIB associated with quality of experience measurement and reporting). The one or more first configuration parameters may be associated with MBS data transmission. In some examples, the one or more first configuration parameters may be associated with one or more MBS bundles. For example, the one or more MBS bundles may comprise a first bundle and a second bundle. The one or more first configuration parameters may comprise first MBS configuration parameters, associated with a first MBS bundle, and second configuration parameters associated with a second MBS bundle. In some examples, the one or more first configuration parameters may comprise multicast control channel (MCCH) configuration parameters of one or more MCCHs. In some examples, the UE may receive control information via the one or more multicast control channels (MCCHs). In some examples, the UE may receive and process one or more multicast traffic channels (MTCHs) based on the control information received via the one or more MCCHs. The MTCCHs may be used by the UE to receive MBS data (e.g., the MTCCHs may be used for carrying MBS data). The one or more first messages may indicate one or more first values of the one or more first configuration parameters. The UE may use the one or more first configuration parameters, using the one or more first values of the one or more first configuration parameters, for receiving first MBS data.

The one or more second configuration parameters may be for reporting quality of experience (QoE) metrics. In an example, a QoE metric, in the one or more QoE metrics, may be based on one or more of a received signal received power (RSRP), a received signal received quality (RSRQ) and a block error rate (BLER). In an example, a QoE metric, in the one or more QoE metrics, may be based on (e.g., based on measurements performed for) at least one of a MCCH and a MTCH. The UE may transmit a report based on the one or more second configuration parameters. The report may comprise time-stamped and/or location-stamped measurement reports. In some examples, the UE may be in an RRC connected state. In some examples, the UE may be in an RRC idle state or an RRC inactive state. In some examples, the transmitting the report may be while the UE is in the RRC connected state. In some examples, the transmitting the report may be while the UE is in the RRC idle state or while the UE is in the RRC inactive state. In some examples, the one or more second configuration parameters may further be used for measurements used in determination of the quality of experience metrics. The report may comprise values of one or more quality of experience metrics. In some examples, the transmission of the report may be based on RRC signaling.

In some examples, the transmission of the report may be in response to a trigger (e.g., a physical layer signaling or a MAC layer signaling). In some examples, the one or more second configuration parameters (for reporting the quality of experience metrics) may comprise an IE that indicates the trigger for the report. In some examples, the transmission of the report may be based on one or more conditions/criteria. In some examples, the one or more criteria used in determining whether to transmit the report may be based on at least one of a RSRP or an RSRQ or BLER (e.g., associated with/based on MCCH and/or MTCH). In some examples, the transmission of the report may be based on at least one of a measurement threshold, a measurement range, one or more time window, one or more reporting trigger events and a reporting time windows. In some examples, the transmission of the report may be based on a randomization parameter (e.g., a probability, e.g., based on a UE ID, etc.). In some examples, transmission of the report may be via a configured grant resource and using a configured grant configuration associated with quality of experience reporting in an RRC inactive state or an RRC idle state (e.g., using a small data transmission (SDT) mechanism in an RRC inactive state). In some examples, transmission of the report may be via a random access resource and using a random access configuration associated with quality of experience reporting in an RRC inactive state or an RRC idle state (e.g., using a small data transmission (SDT) mechanism in an RRC inactive state). For example, the wireless device may receive an RRC release message comprising the configured grant configuration parameters or the random access configuration parameters.

In response to transmitting the report (e.g., in response to the one or more quality of experience metrics having the values indicated by the report), the UE may receive one or more second messages comprising the one or more first configuration parameters with one or more second values. In response to transmitting the report e.g., in response to the one or more quality of experience metrics having the values indicated by the report), the UE may receive the one or more second messages that may include updated value of the one or more first configuration parameters. Based on receiving the report by the BS, the BS may determine to update the value of the one or more first configuration parameters and may send the one or more second messages comprising the one or more first configuration parameters with updated values. The UE may use the one or more first configuration parameters, using the one or more second values of the one or more first configuration parameters, for receiving second MBS data.

In an example embodiment, a user equipment (UE) may receive, from a base station (BS), one or more first messages comprising: one or more first values of one or more first configuration parameters associated with MBS data transmission; and one or more second configuration parameters for reporting one or more quality of experience metrics. The UE may transmit a report based on the one or more second configuration parameters. The UE may receive, from the BS and in response to transmitting the report, one or more second messages comprising one or more second values of the one or more first configuration parameters.

In some examples, the one or more first messages and the one or more second messages may be radio resource control (RRC) messages.

In some examples, the transmitting the report may be based on a radio resource control (RRC) message.

In some examples, the transmitting the report may be while the user equipment (UE) is in a radio resource control (RRC) connected state.

In some examples, the transmitting the report may be while the user equipment (UE) is in a radio resource control (RRC) idle state or an RRC inactive state.

In some examples, the report may comprise values of the one or more quality of experience metrics. The receiving the one or more second messages may be based on the values.

In some examples, the UE may receive, before receiving the one or more second messages, first multicast and broadcast services (MBS) data based on the one or more first values of one or more first configuration parameters. The UE may receive, after receiving the one or more second messages, second MBS data based on the one or more second values of one or more first configuration parameters.

In some examples, the one or more first configuration parameters comprise multicast control channel (MCCH) configuration parameters of one or more MCCHs. In some examples, the UE may receive control information via the one or more multicast control channels (MCCHs). In an example, the UE may receive and may process one or more multicast traffic channels (MTCHs) based on the control information. In some examples, the UE may receive the multicast and broadcast services (MBS) data based on the one or more multicast traffic channels (MTCHs).

In some examples, the one or more first configuration parameters may comprise first multicast and broadcast services (MBS) parameters associated with a first MBS bundle and second parameters associated with a second MBS bundle.

In some examples, the report may comprise time-stamped measurements associated with the one or more quality of experience metrics.

In some examples, the report may comprise location-stamped measurements associated with the one or more quality of experience metrics.

In some examples, the UE may receive control information indicating triggering of reporting the one or more quality of experience metrics. In an example, the triggering of the reporting may be based on physical layer signaling. In some examples, the triggering the reporting may be based on medium access control (MAC) layer signaling.

In some examples, the one or more quality of experience metrics may be based on at least one of received signal received power (RSRP) and received signal received quality (RSRQ) and block error rate (BLER).

In some examples, the one or more quality of experience metrics may be associated with at least one of multicast control channel (MCCH) and multicast traffic channel (MTCH).

In some examples, at least a portion of the one or more first configuration parameters may be received based on a broadcast message. In some examples, the broadcast message may comprise system information indicating the at least a portion of the one or more first configuration parameters. In some examples, the broadcast message may be a system information block (SIB) message. In some examples, the system information block (SIB) message may be associated with quality of experience measurement and reporting. In some examples, the broadcast message may comprise multicast and broadcast services (MBS) bundle-specific configuration parameters.

In some examples, the UE may receive multicast control channel (MCCH) configuration parameters comprising at least a portion of the one or more first configuration parameters. In some examples, the multicast control channel (MCCH) configuration parameters may comprise multicast and broadcast services (MBS) bundle-specific configuration parameters.

In some examples, the one or more second configuration parameters may comprise an information element that is a trigger for reporting the one or more quality of experience metrics.

In some examples, the transmitting the report may further be based one or more criteria. In some examples, the one or more criteria may be based on at least one of a range of received signal received power (RSRP) and received signal received quality (RSRQ) and block error rate (BLER).

In some examples, the transmitting the report may be based on at least one of a measurement threshold, measurement range, time windows, reporting trigger events and reporting time windows.

In some examples, the transmitting the report may be based on randomization parameter. In some examples, the randomization parameter may be based on a probability. In some examples, the randomization parameter may be based on a user equipment (UE) identifier.

In some examples, the user equipment (UE) may be in one of a radio resource control (RRC) inactive state and an RRC idle state. The transmitting the report may be based on a configured grant resource. In some examples, the user equipment (UE) may receive configuration parameters of a configured grant configuration in an inactive state, wherein the configured grant resource may be associated with the configured grant configuration. In some examples, the UE may receive a radio resource control (RRC) release message comprising the configuration parameters of the configured grant configuration.

In some examples, the user equipment (UE) may be in one of a radio resource control (RRC) inactive state and an RRC idle state. The transmitting the report may be based on a random access process. In some example, the UE may receive random access configuration parameters in an inactive state or an idle state, wherein the random access process may be based on the random access configuration parameters.

The exemplary blocks and modules described in this disclosure with respect to the various example embodiments may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. Examples of the general-purpose processor include but are not limited to a microprocessor, any conventional processor, a controller, a microcontroller, or a state machine. In some examples, a processor may be implemented using a combination of devices (e.g., a combination of a DSP and a microprocessor, multiple microprocessors, one or more microprocessors in conjunction with a DSP core, or any other such configuration).

The functions described in this disclosure may be implemented in hardware, software executed by a processor, firmware, or any combination thereof. Instructions or code may be stored or transmitted on a computer-readable medium for implementation of the functions. Other examples for implementation of the functions disclosed herein are also within the scope of this disclosure. Implementation of the functions may be via physically co-located or distributed elements (e.g., at various positions), including being distributed such that portions of functions are implemented at different physical locations.

Computer-readable media includes but is not limited to non-transitory computer storage media. A non-transitory storage medium may be accessed by a general purpose or special purpose computer. Examples of non-transitory storage media include, but are not limited to, random access memory (RAM), read-only memory (ROM), electrically erasable programmable ROM (EEPROM), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable media.

As used in this disclosure, use of the term “or” in a list of items indicates an inclusive list. The list of items may be prefaced by a phrase such as “at least one of” or “one or more of”. For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise”, “include” or “contain” may be used interchangeably and have the same meaning and are to be construed as inclusive and open-ending. The terms “comprise”, “include” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

1. A method of multicast and broadcast services (MBS) data transmission, comprising the steps of:
receiving, by a user equipment (UE) from a base station (BS), one or more first messages comprising:
one or more first configuration parameters, with one or more first values, associated with MBS data transmission; and
one or more second configuration parameters for reporting one or more quality of experience metrics;
transmitting a report based on the one or more second configuration parameters;
receiving, by the UE from the BS and in response to transmitting the report, one or more second messages comprising the one or more first configuration parameters, with one or more second values.

2. The method of claim 1, wherein the one or more first messages and the one or more second messages are radio resource control (RRC) messages.

3. The method of claim 1, wherein the transmitting the report is further based on a radio resource control (RRC) message.

4. The method of claim 1, wherein transmitting the report occurs while the user equipment (UE) is in a radio resource control (RRC) connected state.

5. The method of claim 1, wherein transmitting the report occurs while the user equipment (UE) is in a radio resource control (RRC) idle state or an RRC inactive state.

6. The method of claim 1, wherein
the report comprises values of the one or more quality of experience metrics; and
the receiving the one or more second messages is based on the one or more second values.

7. The method of claim 1, further comprising:
receiving, before receiving the one or more second messages, first multicast and broadcast services (MBS) data based on the one or more first values of the one or more first configuration parameters; and
receiving, after receiving the one or more second messages, second MBS data based on the one or more second values of the one or more first configuration parameters.

8. The method of claim 1, wherein the one or more first configuration parameters comprise multicast control channel (MCCH) configuration parameters of one or more MCCHs.

9. The method of claim 8, further comprising receiving control information via the one or more multicast control channels (MCCHs).

10. The method of claim 9, further comprising receiving and processing the one or more multicast traffic channels (MTCHs) based on the control information.

11. The method of claim 10, further comprising receiving the multicast and broadcast services (MBS) data based on the one or more multicast traffic channels (MTCHs).

12. The method of claim 1, wherein the one or more first configuration parameters comprise first multicast and broadcast services (MBS) parameters associated with a first MBS bundle and second MBS parameters associated with a second MBS bundle.

13. The method of claim 1, wherein the report comprises time-stamped measurements associated with the one or more quality of experience metrics.

14. The method of claim 1, wherein the report comprises location-stamped measurements associated with the one or more quality of experience metrics.

15. The method of claim 1, further comprising receiving control information indicating a triggering of the reporting the one or more quality of experience metrics.

16. The method of claim 15, wherein the triggering of the reporting is based on physical layer signaling.

17. The method of claim 15, wherein the triggering of the reporting is based on medium access control (MAC) layer signaling.

18. The method of claim 1, wherein the one or more quality of experience metrics are based on at least one of a received signal received power (RSRP), a received signal received quality (RSRQ) and a block error rate (BLER).

19. The method of claim 1, wherein the one or more quality of experience metrics are associated with at least one of a multicast control channel (MCCH) and a multicast traffic channel (MTCH).

20. The method of claim 1, wherein at least a portion of the one or more first configuration parameters is received based on a broadcast message.
